(19) United States
(12) Patent Application Publication
(10) Pub. No.: US 2025/0079102 A1
(43) Pub. Date: Mar. 6, 2025

(54) SWITCHING DEVICE WITH PYROTECHNIC ACTUATION APPARATUS

(71) Applicant: Xiamen Hongfa Electric Power Controls Co., Ltd., Xiamen (CN)

(72) Inventors: Shuming ZHONG, Xiamen (CN); Songsheng CHEN, Xiamen (CN); Wenguang DAI, Xiamen (CN); Yaosheng HONG, Xiamen (CN)

(21) Appl. No.: 18/725,862

(22) PCT Filed: Dec. 19, 2022
(86) PCT No.: PCT/CN2022/139878

§ 371 Date: Jul. 1, 2024

(30) Foreign Application Priority Data
Dec. 30, 2021 (CN) 202111658910.5
Dec. 30, 2021 (CN) 202111658928.5
Dec. 30, 2021 (CN) 202111663554.6
Dec. 30, 2021 (CN) 202111682514.6
Dec. 30, 2021 (CN) 202123431365.4

(51) Int. Cl. H01H 50/64; H01H 50/02; H01H 50/54

(52) U.S. Cl. CPC H01H 50/64; H01H 50/023; H01H 50/54

(57) ABSTRACT

A switch apparatus having pyrotechnic actuator includes a itch body and the pyrotechnic actuator. The switch body includes a static contact part which is fixed and a movable contact part which is movable. The pyrotechnic actuator is an independent modular construction and is fixedly mounted on the switch body from the outside of the switch body. The pyrotechnic actuator can ignite gunpowder to generate an explosive impact force that pushes the movable contact part away from the static contact part according to the load condition of the switch body, so as to assist the switch apparatus to be quickly disconnected.

### CROSS-REFERENCE TO RELATED APPLICATIONS

This application is a national stage of International Application No. PCT/CN2022/139878, filed on Dec. 19, 2022, which claims the benefit of and priority to Chinese Patent Application Nos. 202111682514.6, 202123431365.4, 202111658928.5, 202111658910.5, and 202111663554.6, all filed on Dec. 30, 2021, all of which being incorporated by reference in their entireties herein.

### TECHNICAL FIELD

The present disclosure relates to the field of switch apparatuses and, in particular, to a switch apparatus having a pyrotechnic actuator.

### BACKGROUND

The relay is widely used in remote control, telemetry, communication, automatic control, mechatronics, and power electronic equipment, and is a core component for controlling the switch state in the electrical circuit. With the continuous development and replacement of electrical technology, main circuit load requirements are getting higher and higher, and anti-short circuit requirements of the relay are also getting higher and higher. In recent years, some manufacturers have proposed 20 KA or even 30 KA main circuit anti-short circuit ability. Under such a high short circuit, a huge short circuit electro-dynamic repulsion force will appear between the contacts of the relay, forcing the movable contact piece to be repelled from the static contact. In order to resist the short circuit electro-dynamic repulsion force to maintain the closed state of the movable contact piece and the static contact, it is necessary to increase the pressure of the contact spring or the closing magnetic attractive force of the movable contact piece (that is, the magnetic attractive force that drives the movable contact piece to move through the electromagnetic drive mechanism) to resist the electro-dynamic repulsion force. However, when the pressure of the contact spring or the closing magnetic attractive force of the movable contact piece increases, the normal breaking action of the movable contact piece will also be affected. When the short circuit increases further, if the breaking is not timely, the circuit safety cannot be guaranteed. Therefore, in some existing technologies, a pyrotechnic actuator is disposed to help the relay to break quickly. When the system detects that the short circuit reaches a critical value, the actuator is excited to ignite gunpowder, and the impact force of the gunpowder explosion is used to push the movable contact (the movable contact piece) to disconnect quickly, thereby realizing the circuit protection function.

The existing pyrotechnic actuator is usually integrated into the relay and has an integrated structure with the relay, which results in more parts for the relay, more complicated manufacturing and assembly processes, and higher costs. The existing pyrotechnic actuator cannot be replaced. When the load current changes, the pyrotechnic actuator cannot be replaced alone, but the entire relay must be replaced with another specification, which is inconvenient.

### BRIEF SUMMARY

A switch apparatus is disclosed having a pyrotechnic actuator, including a switch body and a pyrotechnic actuator arranged on the switch body. The switch body includes a fixed static contact part and a movable contact part to perform a switch function, the pyrotechnic actuator is an independent modular construction, the pyrotechnic actuator as an independent module is fixedly installed on the switch body from the outside, and can ignite gunpowder according to the load condition of the switch body to generate an explosive impact force that pushes the movable contact part away from the static contact part, so as to assist the switch apparatus to disconnect quickly.

In an embodiment, the switch body includes a movable contact part that is arranged inside the outer housing, and one end of the pyrotechnic actuator extends into the outer housing to be arranged opposite to one side of the movable contact part.

Based on manufacturing and installation considerations, in an embodiment, the pyrotechnic actuator includes an actuator, a piston, and a bottom shell, the actuator and the bottom shell are joined and fixed, the bottom shell is a hollow structure, the piston is cooperatively installed in the bottom shell, and the bottom shell extends into the inner part of the outer housing and faces the movable contact part. When the pyrotechnic actuator is excited, the actuator ignites gunpowder and pushes the piston to break through the bottom shell through the gas, and the piston moves toward the movable contact part under the guidance of the bottom shell, thereby pushing the movable contact part to be away from the static contact part.

In order to gather the impact force when the pyrotechnic actuator is ignited at the lower end of the bottom shell, thereby enhancing the ability of the piston to break the bottom shell, in one embodiment, the bottom shell is a structure that gradually contracts toward the movable contact part.

In order to break the bottom shell more quickly and push the movable contact piece to disconnect quickly, in one embodiment, the piston is structured to be gradually contracted toward the movable contact part.

In order to improve the arc extinguishing ability of the switch apparatus, in an embodiment, an arc-extinguishing medium is further stored in the piston or the bottom shell. After the piston breaks through the bottom shell, the arc-extinguishing medium is released into the contact chamber through the rupture of the piston or the bottom shell to extinguish the arc between the static contact part and the movable contact part.

In one embodiment, the actuator includes a hollow actuator base, one end of the actuator base is provided with the first flange, one end of the bottom shell is provided with the second flange, the first flange and the second flange are connected and fixed to each other so that the actuator and the bottom shell are connected and fixed.

In one embodiment, based on manufacturing and installation considerations, the second flange is fixed to the outer housing by welding, and the second flange is provided with an annular rib for improving welding stability.

Based on manufacturing and installation considerations, in one embodiment, the actuator further includes a connector, an igniter and a sealing ring fixedly installed inside the actuator base, the connector is clamped and fixed on the inner wall of the actuator base, and the sealing ring is pressed into the actuator base by interference fit. In the actuator base, one end of the sealing ring presses the igniter toward the connector, and the other end presses the piston toward the bottom shell.

In order to improve the electrical performance, in one embodiment, the switch body further includes a ceramic cover which is arranged inside the outer housing and covers the static contact part and the movable contact part as well as the contact parts of the static contact part and the movable contact part, the ceramic cover is provided with a mounting hole, one end of the pyrotechnic actuator passes through the mounting hole and is welded and fixed to the ceramic cover to seal the mounting hole.

In order to quickly replace the pyrotechnic actuator according to load requirements, in one embodiment, the pyrotechnic actuator is fixedly connected to the switch body in a detachable manner.

In an embodiment, the switch apparatus is a direct current high voltage relay.

### BRIEF DESCRIPTION OF THE DRAWINGS

The above and other features and advantages of the present disclosure will become more apparent by describing in detail example embodiments thereof with reference to the attached drawings.

FIG. 1 is a cross-sectional view of the relay having the pyrotechnic actuator in the first embodiment (the relay is in a disconnected state).

FIG. 2 is a schematic diagram of the pyrotechnic actuator being inserted and fixedly connected to the ceramic cover in the first embodiment.

FIG. 3 is an exploded view of the pyrotechnic actuator in the first embodiment.

FIG. 4 is a cross-sectional view of the pyrotechnic actuator in the first embodiment.

FIG. 5 is an exploded view (front view) of the actuator in the first embodiment.

FIG. 6 is an exploded view (stereoscopic view) of the actuator in the first embodiment.

FIG. 7 is a cross-sectional view of the relay having the pyrotechnic actuator in the first embodiment (the relay is in a conducting state).

FIG. 8 is a cross-sectional view of the relay with the pyrotechnic actuator in the first embodiment (the pyrotechnic actuator is excited).

FIG. 9 (a) is a schematic diagram of the bottom shell in the second embodiment.

FIG. 9 (b) is a cross-sectional view of the bottom shell in the second embodiment.

FIG. 10 (a) is a schematic diagram of the bottom shell in the third embodiment.

FIG. 10 (b) is a cross-sectional view of the bottom shell of the third embodiment.

FIG. 11 is a schematic diagram of a feasible structure of the piston in the fourth embodiment.

FIG. 12 is a schematic diagram of another feasible structure of the piston in the fourth embodiment.

FIG. 13 is a schematic diagram of the arc-extinguishing medium stored in the piston in the fifth embodiment.

FIG. 14 is a cross-sectional view of the relay with the pyrotechnic actuator in the sixth embodiment (the relay is in a disconnected state).

FIG. 15 is a schematic diagram of the pyrotechnic actuator being inserted and fixedly connected to the ceramic cover in the sixth embodiment.

FIG. 16 is an exploded view of the pyrotechnic actuator in the sixth embodiment.

FIG. 17 is a cross-sectional view of the pyrotechnic actuator in the sixth embodiment.

FIG. 18 is an exploded view of the actuator in the sixth embodiment (front view).

FIG. 19 is an exploded view (stereoscopic view) of the actuator in the sixth embodiment.

FIG. 20 is a cross-sectional view of the relay with the pyrotechnic actuator in the sixth embodiment (the relay is in the conducted state).

FIG. 21 is a cross-sectional view of the relay with the pyrotechnic actuator in the sixth embodiment (the pyrotechnic actuator is excited).

FIG. 22 is a schematic diagram of the bottom shell in the sixth embodiment.

FIG. 23 is a schematic diagram of the bottom shell expanding outward to form a sharp-toothed non-return portion to limit the rebound of the piston in the sixth embodiment.

FIG. 24 is a schematic perspective view of the push rod assembly in the sixth embodiment.

FIG. 25 is an exploded view of the push rod assembly in the sixth embodiment.

FIG. 26 is a schematic diagram (front view) of the restrain frame being flattened by the impact of the piston in the sixth embodiment.

FIG. 27 is a schematic diagram (stereoscopic view) of the restrain frame being flattened by the impact of the piston in the sixth embodiment.

FIG. 28 is a schematic diagram of the piston in the seventh embodiment.

FIG. 29 is a schematic diagram of the bottom shell expanding outward to form a sharp-toothed non-return portion to limit the rebound of the piston in the seventh embodiment.

FIG. 30 is a schematic diagram of the piston in the eighth embodiment.

FIG. 31 is a schematic diagram of a feasible structure of the piston in the ninth embodiment.

FIG. 32 is a schematic diagram of another feasible structure of the piston in the ninth embodiment.

FIG. 33 is a cross-sectional view of the relay with the pyrotechnic actuator in the tenth embodiment (the relay is in a disconnected state).

FIG. 34 is a schematic diagram of the pyrotechnic actuator being inserted and fixedly connected to the ceramic cover in the tenth embodiment.

FIG. 35 is an exploded view of the pyrotechnic actuator in the tenth embodiment.

FIG. 36 is a cross-sectional view of the pyrotechnic actuator in the tenth embodiment.

FIG. 37 is an exploded view of the actuator in the tenth embodiment (front view).

FIG. 38 is an exploded view (stereoscopic view) of the actuator in the tenth embodiment.

FIG. 39 is a cross-sectional view of the relay having the pyrotechnic actuator in the tenth embodiment (the relay is in the conducted state).

FIG. 40 is a cross-sectional view of the relay with the pyrotechnic actuator in the tenth embodiment (the pyrotechnic actuator is excited).

FIG. 41 is a perspective schematic diagram of the push rod assembly in the tenth embodiment.

FIG. 42 is an exploded view of the push rod assembly in the tenth embodiment.

FIG. 43 is a schematic diagram (front view) of the restrain frame being flattened by the impact of the piston in the tenth embodiment.

FIG. 44 is a schematic diagram (stereoscopic view) of the restrain frame being flattened by the impact of the piston in the tenth embodiment.

FIG. 45 is a schematic diagram of the movable contact piece and the magnetic conduction ring assembly in the tenth embodiment.

FIG. 46 is a schematic diagram of the magnetic conduction ring assembly generating attraction force to resist the electro-dynamic repulsion force of the short circuit in the tenth embodiment.

FIG. 47 is a schematic diagram of the movable contact piece and the magnetic conduction ring assembly in the eleventh embodiment.

FIG. 48 is a schematic diagram of the movable contact piece and the magnetic conduction ring assembly in the twelfth embodiment.

FIG. 49 is a cross-sectional view of the relay with the pyrotechnic actuator in the thirteenth embodiment (the relay is in a disconnected state).

FIG. 50 is a schematic diagram of the pyrotechnic actuator being inserted and fixedly connected to the ceramic cover in the thirteenth embodiment.

FIG. 51 is an exploded view of the pyrotechnic actuator in the thirteenth embodiment.

FIG. 52 is a cross-sectional view of the pyrotechnic actuator in the thirteenth embodiment.

FIG. 53 is an exploded view (front view), of the actuator in the thirteenth embodiment

FIG. 54 is an exploded view (stereoscopic view) of the actuator in the thirteenth embodiment.

FIG. 55 is a cross-sectional view of the relay having the pyrotechnic actuator in the thirteenth embodiment (the relay is in the conducted state).

FIG. 56 is a cross-sectional view of the relay with the pyrotechnic actuator in the thirteenth embodiment (the pyrotechnic actuator is excited).

FIG. 57 is a perspective schematic diagram of the push rod assembly in the thirteenth embodiment.

FIG. 58 is an exploded view of the push rod assembly in the thirteenth embodiment.

FIG. 59 is a schematic diagram (front view) of the restrain frame being flattened by the impact of the piston in the thirteenth embodiment.

FIG. 60 is a schematic diagram (stereoscopic view) of the restrain frame being flattened by the impact of the piston in the thirteenth embodiment.

FIG. 61 is a schematic diagram of the restrain frame applied to the seesaw-type relay contact circuit in the fourteenth embodiment.

FIG. 62 is a schematic diagram (stereoscopic view) of the push rod assembly in the fifteenth embodiment.

FIG. 63 is a schematic diagram (front view) of the push rod assembly in the fifteenth embodiment.

FIG. 64 is a perspective schematic diagram of a U-shaped bracket in the sixteenth embodiment (angle 1).

FIG. 65 is a perspective schematic diagram of a U-shaped bracket in the sixteenth embodiment (angle 2).

FIG. 66 is a cross-sectional view of the relay having the pyrotechnic actuator in the seventeenth embodiment (the relay is in a disconnected state).

FIG. 67 is a schematic diagram of the pyrotechnic actuator being inserted and fixedly connected to the ceramic cover in the seventeenth embodiment.

FIG. 68 is an exploded view of the pyrotechnic actuator in the seventeenth embodiment.

FIG. 69 is a cross-sectional view of the pyrotechnic actuator in the seventeenth embodiment.

FIG. 70 is an exploded view (front view) of the actuator in the seventeenth embodiment.

FIG. 71 is an exploded view (stereoscopic view) of the actuator in the seventeenth embodiment.

FIG. 72 is a cross-sectional view of the relay having the pyrotechnic actuator in the seventeenth embodiment (the relay is in the conducted state).

FIG. 73 is a cross-sectional view of the relay with the pyrotechnic actuator in the seventeenth embodiment (the pyrotechnic actuator excites and releases the arc-extinguishing medium).

FIG. 74 is a schematic diagram of the arc-extinguishing medium stored in the piston in the eighteenth embodiment.

FIG. 75 (a) is a schematic diagram of the bottom shell in the twentieth embodiment (front view).

FIG. 75 (b) is a cross-sectional view of the bottom shell in the twentieth embodiment.

FIG. 76 (a) is a schematic diagram of another feasible modification of the bottom shell in the twentieth embodiment (front view).

FIG. 76 (b) is a cross-sectional view of another feasible modification of the bottom shell in the twentieth embodiment.

FIG. 77 is a schematic diagram of the piston in the twenty-first embodiment.

FIG. 78 is a schematic diagram of another possible alternative to the piston in the twenty-first embodiment.

### DETAILED DESCRIPTION

Exemplary embodiments will now be described more fully by reference to the accompanying drawings. However, the exemplary embodiments can be implemented in various forms and should not be understood as being limited to the examples set forth herein. Although terms having opposite meanings such as “up” and “down” are used herein to describe the relationship of one component relative to another component, such terms are used herein only for the sake of convenience, for example, “in the direction illustrated in the figure”. It can be understood that if a device denoted in the drawings is turned upside down, a component described as “above” something will become a component described as “under” something. When a structure is described as “above” another structure, it probably means that the structure is integrally formed on another structure, or, the structure is “directly” disposed on another structure; or, the structure is “indirectly” disposed on another structure through an additional structure.

Words such as “one”. “an/a”. “the”, and “said” are used herein to indicate the presence of one or more elements/component parts/and others. Various terms, such as “including” and “having.” have an inclusive meaning which means that there may be additional elements/component parts/and others in addition to the listed elements/component parts/and others. Terms “first”, “second”, “third”, and “fourth” are used herein only as markers or labels, and they do not limit the number of objects modified after them.

### The First Embodiment

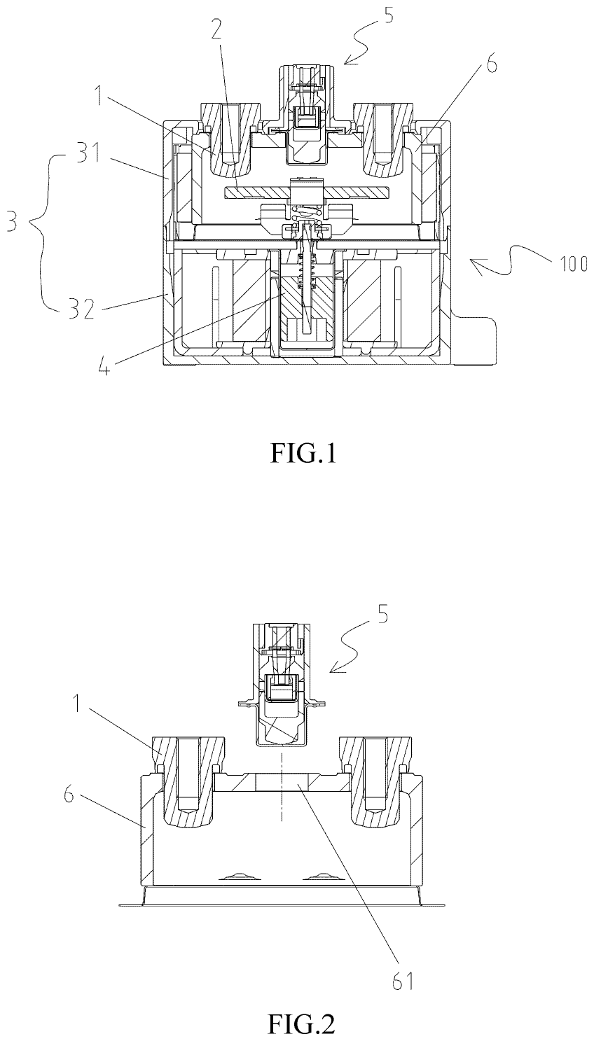

Referring to FIGS. 1-2, as an embodiment of the present disclosure, a relay having a pyrotechnic actuator is provided includes a relay body 100 and a pyrotechnic actuator 5 mounted on the relay body 100. The relay body 100 includes a static contact 1 (as the static contact part) and a movable contact piece 2 (as the movable contact part) for realizing the connection or disconnection thereof. The relay body 100 also includes an outer housing 3, one end of the static contact 1 is exposed outside of the outer housing 3 and electrically connected to the external load, and the other end is inserted into the inner part of the outer housing 3. The movable contact piece 2 is arranged inside the outer housing 3 and connected to an electromagnetic drive mechanism 4. The static contact 1 is provided with an internal thread, which can be used to be threadedly connected and fixed with the external terminal. The movable contact piece 2 is a bridge-type movable contact piece. Under the action of the electromagnetic drive mechanism 4, the movable contact piece 2 can move relatively close to or away from the static contact 1. When the movable contact piece 2 contacts two static contacts 1 at the same time, the load is connected. For the convenience of description, it is described that the static contact 1 is relatively above the movable contact piece 2, and the movable contact piece 2 is relatively below the static contact 1.

The relay body 100 further includes a ceramic cover 6, which is fixedly arranged inside the outer housing 3 and covers the lower end of the static contact 1 and the movable contact piece 2 (i.e., covers the static contact 1, the movable contact piece 2 and the contacts between them) to form a contact chamber. The ceramic cover 6 isolates the contacts between the static contact 1 and the movable contact piece 2 from the outside air to obtain high voltage resistance performance, which can effectively ensure low contact resistance, long service life and high reliability of the relay. When the relay is short-circuited, the arc resistance and high temperature resistance of the ceramic material can ensure safety and reliability of the circuit under the short-circuit arc.

The outer housing 3 further includes a base 32 and a cover 31 which are engaged with each other. The ceramic cover 6 is arranged inside the cover 31. The pyrotechnic actuator 5 is inserted from the outside of the ceramic cover 6 and fixedly connected to the ceramic cover 6. The lower end of the pyrotechnic actuator 5 extends into the contact chamber of the ceramic cover 6 and faces the movable contact piece 2. The cover 31 is then covered on the ceramic cover 6 and the pyrotechnic actuator 5 to complete the overall assembly of the relay.

Referring to FIG. 2, the pyrotechnic actuator 5 is an independent modular construction, and its appearance is generally a columnar rotating body structure. A mounting hole 61 is provided at the upper end of the ceramic cover 6, and the lower end of the pyrotechnic actuator 5 extends into the contact chamber through the mounting hole 61. The pyrotechnic actuator 5 can be fixed to the ceramic cover 6 by welding, riveting, screwing, etc. In this embodiment, the pyrotechnic actuator 5 is fixed to the ceramic cover 6 by brazing.

In this embodiment, the top surface of the cover 31 has through holes and the hollow cylindrical section for mounting and matching two static contacts 1 and one pyrotechnic actuator 5, so that the top ends of the two static contacts 1 can be exposed from the outer housing 3, and the outside of the pyrotechnic actuator 5 can be covered and protected. In addition, in order to improve electrical safety, a protective baffle extends from both sides of the outer wall of the hollow cylindrical section in a direction perpendicular to the illustrated paper (not shown in the figure due to the shown angle).

In other embodiments, the pyrotechnic actuator 5 may also be fixedly connected to the outer housing 3; however, in this embodiment, the pyrotechnic actuator 5 is fixedly connected to the ceramic cover 6 to simplify an assembly process. During final assembly, the pyrotechnic actuator 5 and the static contact 1 are fixedly assembled on the ceramic cover 6 and then the cover 31 is covered.

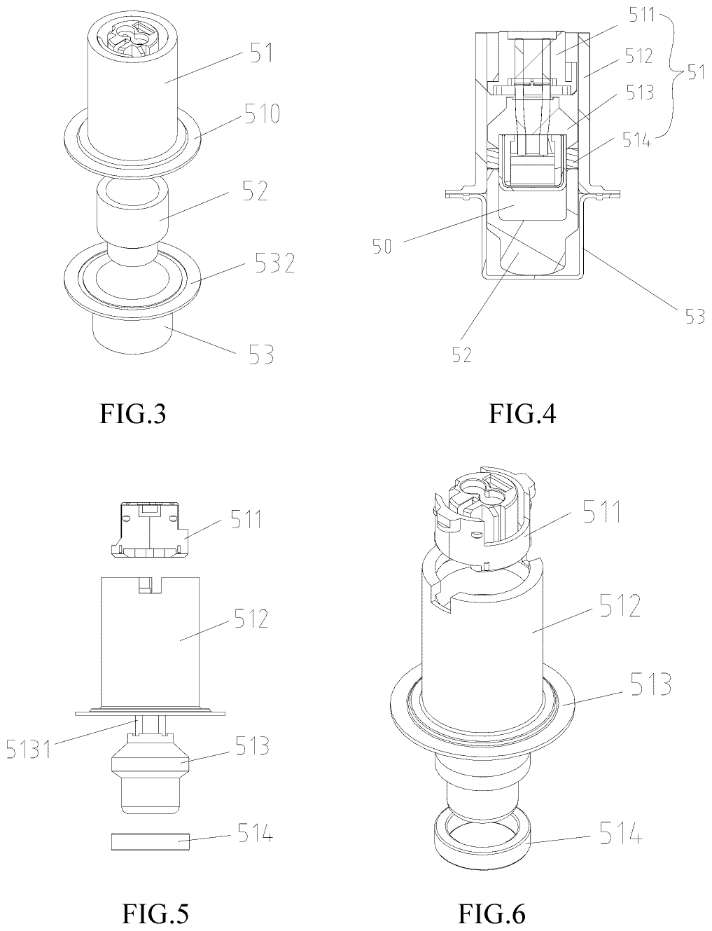

Referring to FIGS. 3-6, the pyrotechnic actuator 5 specifically includes an actuator 51, a piston 52, and a bottom shell 53. The actuator 51 and the bottom shell 53 are fixedly connected one above the other, and the piston 52 is accommodated between the actuator 51 and the bottom shell 53. The actuator 51 further includes a hollow actuator base 512 as well as a connector 511, an igniter 513, and a sealing ring 514 fixedly installed inside the actuator base 512. The actuator base 512 is a cylindrical structure, and a first flange 510 is provided at the lower end thereof. The bottom shell 53 is also a hollow cylindrical structure, and a second flange 532 is provided at the upper end of the bottom shell 53. The first flange 510 and the second flange 532 are connected and fixed together (e.g., welding, riveting, or screwing) to achieve the connection and fixation of the actuator 51 and the bottom shell 53. The lower end of the bottom shell 53 extends into the contact chamber of the ceramic cover 6, and the second flange 532 is brazed and fixed on the ceramic cover 6 to achieve the fixed connection between the pyrotechnic actuator 5 and the ceramic cover 6.

As shown in FIG. 4, an annular rib 531 is provided on the side of the second flange 532 facing the ceramic cover 6, and the annular rib 531 can further increase the stability of the brazing between the second flange 532 and the ceramic cover 6. In addition, since the first flange 510 and the second flange 532 form an outwardly expanded diameter portion to further seal the mounting hole 61, airtightness of the ceramic cover 6 can be ensured.

In this embodiment, the actuator base 512 and the bottom shell 53 are fixedly connected to form the outer housing of the pyrotechnic actuator 5. The connector 511, the igniter 513, the sealing ring 514, and the piston 52 are sequentially arranged inside the outer housing from top to bottom, and the connector 511 is connected to a lead 5131 of the igniter 513. The connector 511 is fixedly connected to the outer housing by clamping. The sealing ring 514 is pressed into the inner wall of the actuator base 512 by interference fit, and the actuator base 512 presses the igniter 513 upward and fixes it. The upper and lower ends of the piston 52 are respectively pressed by the sealing ring 514 and the bottom shell 53. The sealing ring 514 can play roles of moisture-proof and air-tight. The micro-deformation of the sealing ring 514 under pressure can further press the igniter 513 above and the piston 52 below to prevent vibration loosening.

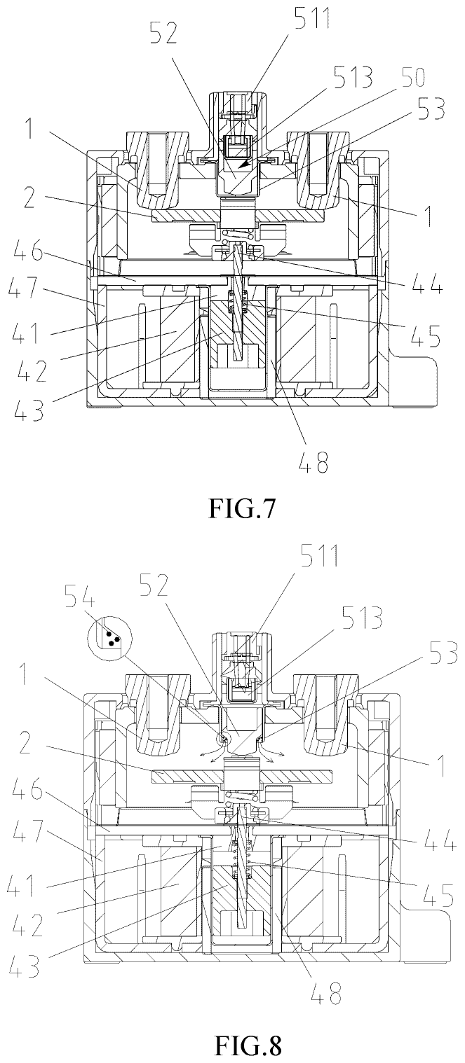

Referring to FIGS. 7-8, the connector 511 is used to fix the ignition lead of the monitoring excitation circuit to transmit the excitation electrical signal emitted by the monitoring excitation circuit to excite the igniter 513. The monitoring excitation circuit may emit an excitation electrical signal to be transmitted downward through the connector 511 after the monitoring current value (or current climbing rate) reaches a certain threshold value, and excite the igniter 513 to ignite. An air gap 50 is provided between the piston 52 and the igniter 513. After the igniter 513 ignites the gunpowder, high-pressure gas is generated in the air gap 50) (i.e., ignition is performed), pushing the piston 52 downward to break through the bottom shell 53, and then the piston 52 pushes the movable contact piece 2 to move downward, helping the movable contact piece 2 to disconnect with the contact with the static contact 1, and realizing the rapid disconnection of the relay.

The bottom shell 53 is a hollow cylindrical structure, and the piston 52 is a rotating body structure arranged inside the bottom shell 53 through the shaft hole, so that the bottom shell 53 can guide the piston 52, thus the piston 52 moves axially downward along the inner chamber of the hollow cylindrical bottom shell 53 after the igniter 513 is ignited.

In this embodiment, the pyrotechnic actuator 5 is a modular construction, which is independent from the relay body and can be manufactured separately and then fixedly installed on the relay. The manufacture and transportation of the pyrotechnic actuator 5 are easy to control, the number of parts is small, and it is easy to assemble. The standardization of parts is also easier to achieve, so as to achieve the purpose of reducing weight, reducing costs and improving performance. In addition, the igniter 513 extends a lead 5131 to connect with the ignition lead of the monitoring excitation circuit through the connector 511, so that the gunpowder in the igniter 513 is far away from the lead-out end of the ignition lead, the temperature rise is low, and the temperature resistance requirement of the gunpowder is reduced.

In this embodiment, the pyrotechnic actuator 5 is applied to a ceramic sealed relay. Specifically, the pyrotechnic actuator 5 is welded to the ceramic cover 3. The welding has good fastness, the sealing and vibration resistance of the pyrotechnic actuator 5 are better. In addition, the outer housing of the pyrotechnic actuator 5 is more simply molded, and the product height is lower.

In other embodiments, the pyrotechnic actuator 5 can also be applied to a relay of other structures, as long as a mounting hole (such as the mounting hole 61 of this embodiment) is provided on the relay body for the pyrotechnic actuator 5 to be inserted, and the pyrotechnic actuator 5 is attached to the relay by a fixed connection method. The pyrotechnic actuator 5 can also be fixed to the relay body by a detachable connection (such as a screw connection), so that the pyrotechnic actuator 5 can be quickly replaced according to input requirements.

As shown in FIG. 8, an arc-extinguishing medium 54 is further provided in the bottom shell 53 of the pyrotechnic actuator 5. When the pyrotechnic actuator 5 is excited, the piston 52 breaks through the bottom shell 53 downward to release the arc-extinguishing medium 54 into the contact chamber of the ceramic cover 6, thereby extinguishing the arc of the contact gap between the static contact 1 and the movable contact piece 2, further accelerating the arc extinguishing ability when the contacts are disconnected, and improving the short-circuit safety of the product.

In this embodiment, the arc-extinguishing medium 54 is quartz sand. Since the gas at the lower end of the pyrotechnic actuator 5 expands rapidly after ignition and explosion, the arc-extinguishing medium 54 stored in the bottom shell 53 or the piston 52 can be evenly spread in the contact chamber along with the explosion gas very quickly, and is not limited by the outer shape of the static contact 1 and the movable contact piece 2 and the inner contour of the contact chamber to the greatest extent, and can directly play the arc extinguishing effect in a very short time.

In this embodiment, since the movable contact piece 2 is a bridge-type movable contact piece, and the static contact 1 is disposed on two ends of bridge-type movable contact piece. The pyrotechnic actuator 5 is arranged at one side of the middle section of the movable contact piece 2. The expansion gas after the pyrotechnic actuator 5 is ignited and exploded will be blocked by the bridge-type movable contact piece, which makes the airflow go to two ends of the bridge-type movable contact piece, so that the arc-extinguishing medium 54 can reach the area between the static contact 1 and the movable contact piece 2 more directly

Referring to FIGS. 7-8, the electromagnetic drive mechanism 4 is used to drive the movable contact piece 2 to move. The electromagnetic drive mechanism 4 specifically includes a static iron core 41, a coil 42, a movable iron core 43, a push rod assembly 44 and a reset spring 45, as well as a first yoke 46, a second yoke 47 and a magnetic cylinder 48 for transmitting magnetic lines of flux and improving the utilization rate of magnetic energy. The lower end of the push rod assembly 44 is fixedly connected to the movable iron core 43, and the upper end is linked to the movable contact piece 2. One end of the reset spring 45 acts on the static iron core 41, and the other end acts on the movable iron core 43. When the coil 42 is powered on, the static iron core 41 attracts the movable iron core 43 to move upward, so that the push rod 44 pushes the movable contact piece 2 upward; When the coil 42 is powered off, the electromagnetic drive mechanism 4 is reset under the elastic force of the reset spring 45. The electromagnetic drive mechanism 4 is a common direct-moving magnetic circuit structure, and its operating principle is not described in detail in this embodiment.

This embodiment uses a relay structure to illustrate the function and effect of the pyrotechnic actuator 5. In addition to the relay, the same structure can also be applied to other switch apparatuses, such as contactors.

### The Second Embodiment

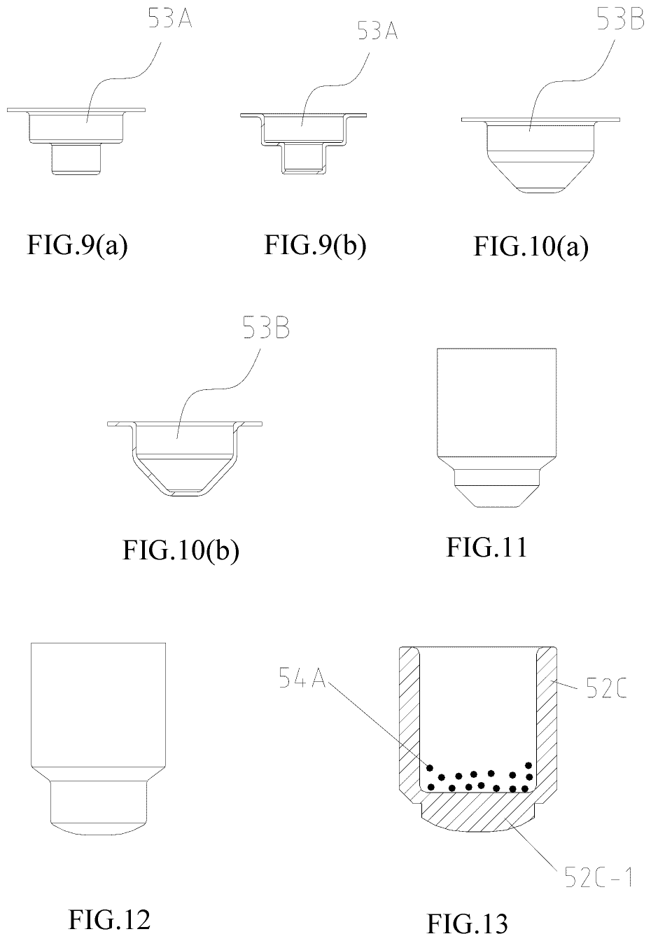

This embodiment proposes a relay, whose structure is similar to the relay of the first embodiment, and the only difference is that this embodiment adopts a different bottom shell structure of the pyrotechnic actuator. Referring to FIG. 9 (a) and FIG. 9 (b), in this embodiment, the bottom shell 53A is a multi-step structure with gradually shrinking radial dimensions from top to bottom. Since the lower end of the bottom shell 53A is in a shrinking shape, the impact force of the pyrotechnic actuator can be gathered on the small step at the lower end of the bottom shell 53A when it is ignited, thereby the local energy is increased, thus enhancing the ability of the piston to break the bottom shell 53A, accelerating the piston to push the movable contact piece 2 to disconnect. At the same time, the arc-extinguishing medium can be stored at the internal step of the bottom shell 53A.

### The Third Embodiment

This embodiment proposes a relay, whose structure is similar to the relay of the second embodiment, and the only difference is that this embodiment adopts a different bottom shell structure of the pyrotechnic actuator. Referring to FIG. 10 (a) and FIG. 10 (b), in this embodiment, the bottom shell 53B is a conical structure with a radial dimension gradually shrinking from top to bottom (i.e., toward the movable contact piece). Similarly, since the lower end of the bottom shell 53B is in a contracted shape, when the pyrotechnic actuator is ignited, the impact force can be gathered at the lower end of the bottom shell 53B, the local energy is increased, thereby enhancing the ability of the piston to break the bottom shell 53B, and accelerating the piston to push the movable contact piece 2 to be disconnected from the static contact.

The present embodiment and the second embodiment adopt the structure of setting the bottom shell to gradually shrink the radial dimension from top to bottom. In addition to the “step-type shrinkage” and “conical shrinkage” proposed in the present embodiment and the second embodiment, in other embodiments, the “step-type shrinkage” and “conical shrinkage” can be combined in multiple stages to achieve shrinkage, and the use of other regular or irregular shapes for radial shrinkage are all feasible solutions.

### The Fourth Embodiment

This embodiment proposes a relay, whose structure is similar to the relay of the first embodiment, and the only difference is that this embodiment adopts a different structure of the piston of the pyrotechnic actuator. In this embodiment, the piston is in a shape that contracts from top to bottom (i.e., toward the movable contact piece), and its force application area is reduced, and the force acting on the bottom shell and the movable contact piece is enhanced, so that the bottom shell can be broken more quickly, and the movable contact piece can be quickly pushed to be disconnected from the static contact. The contraction shape of the lower end of the piston can be realized by using a conical contraction, a step contraction, or a contraction structure combining a conical and a step shape, and the piston with a contracted lower end as shown in FIGS. 11 and 12 is feasible.

### The Fifth Embodiment

This embodiment proposes a relay, whose structure is similar to the relay of the first embodiment, and the only difference is that in this embodiment, the arc-extinguishing medium is stored in the piston, as shown in FIG. 13, the piston 52c is a columnar structure with a central chamber, the arc-extinguishing medium 54a is stored in the piston 52c, and the lower end 52c-1 of the piston 52c (i.e., the impact part of the piston 52c) is a thin and fragile structure. The lower end 52c-1 of the piston 52c is made of fragile materials such as BAKELITE® or PBT plastic. When the piston 52c impacts downward, the lower end of the lower end 52c-1 is broken due to the impact, and the crevice is generated, so that the arc-extinguishing medium 54a is released.

In addition to adopting the piston structure with upward opening in this embodiment and the first embodiment, the piston may also be a sealed structure with a closed chamber. When the piston structure with the sealed chamber is adopted, since the arc-extinguishing medium is stored in the piston with good sealing performance, the arc-extinguishing medium may be other arc-extinguishing media such as gaseous sulfur hexafluoride or liquid transformer oil in addition to quartz sand.

In addition, the existing pyrotechnic actuator generally includes a piston. After the pyrotechnic actuator is ignited, the high-pressure gas pushes the piston to move, and the piston pushes the movable contact (the movable contact piece) to quickly disconnect. However, the pyrotechnic actuator of the prior art is not provided with the non-return structure of the piston. After the piston hits the movable contact piece, it is easy to rebound, resulting in a loss of kinetic energy of the piston, which is not conducive to achieving the rapid disconnection of the movable contact piece.

Therefore, the present disclosure further proposes a pyrotechnic actuator with optimized structure. Based on the pyrotechnic actuator, the present disclosure further proposes a switch apparatus having a pyrotechnic actuator.

The present disclosure adopts following technical solutions:

The present disclosure provides a pyrotechnic actuator including an actuator, a piston and a bottom shell. The bottom shell is a hollow in structure. The piston is installed in the bottom shell. The actuator ignites gunpowder and pushes the piston to break through the bottom shell through the gas. The bottom shell is provided with the non-return structure. After the piston breaks through the bottom shell, the non-return structure prevents the piston from rebounding due to impact.

The bottom shell is provided with several staggered crevice at the bottom. After the piston breaks through the bottom shell, the bottom of the bottom shell expands outward from the intersection of the crevice to form a sharp-toothed non-return portion. The tip of the non-return portion abuts against the piston to prevent the piston from rebounding.

The crevice is in [symbol] -shaped (a shape is that multiple line segments intersect at a point) or a cross-shaped.

A radial step difference structure is provided on the piston.

The piston is provided with a neck portion with a reduced diameter, and the tip of the non-return portion abuts against a step at one end of the neck portion to prevent the piston from rebounding; or the piston is divided into two independent sections, including an upper piston and a lower piston, and after the lower piston breaks through the bottom shell, the upper piston still remains in the bottom shell, and the tip of the non-return portion abuts against the end of the lower piston to prevent the lower piston from rebounding.

The piston is a structure that gradually contracts towards the direction of breaking through the bottom shell.

The present disclosure also proposes a switch apparatus having a pyrotechnic actuator, including a switch body and a pyrotechnic actuator arranged on the switch body. The switch body includes a fixed static contact part and a movable contact part to perform a switching function. The pyrotechnic actuator ignites gunpowder according to a load condition of the switch body and generates an explosive impact force that pushes the movable contact part away from the static contact part to assist the switch apparatus in quickly disconnecting, and the pyrotechnic actuator is the above-mentioned pyrotechnic actuator.

The switch apparatus having pyrotechnic actuator further includes a restraint part, the restraint part is arranged at a position corresponding to the piston breaking through the bottom shell, and the restraint part is configured to be coupled and assembled with the movable contact part so as to restrain the movable contact part from returning toward the static contact part, and the material of the restraint part is a material that does not deform after receiving the impact of a pushing medium.

The restrain part is a restrain frame, and the restrain frame is flattened and cannot recover its deformation after receiving the impact of the piston, thereby restraining the movable contact part from returning toward the static contact part.

The movable contact part is a plate-shaped structure, and the restrain frame is straddled on the plate-shaped movable contact part to restrain it from returning to the static contact part.

The switch apparatus is a direct current high voltage relay.

The present disclosure has following beneficial effects; the present disclosure is provided with a non-return structure of the piston, so that the piston can be squeezed out from the bottom of the bottom shell but cannot rebound due to the stop of the non-return structure, the piston can be stuck in time, and the energy loss caused by the rebound of the piston is reduced.

The present disclosure is now further described in conjunction with the accompanying drawings and specific implementation methods.

### The Sixth Embodiment

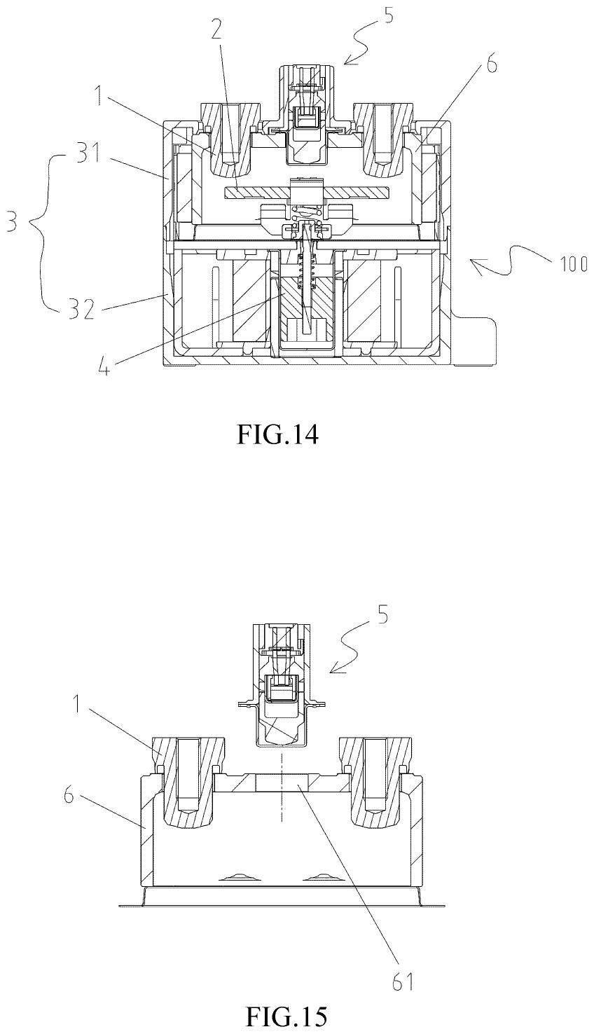

Referring to FIGS. 14-15, as an embodiment of the present disclosure, a relay having a pyrotechnic actuator is provided, which includes a relay body 100 and a pyrotechnic actuator 5 mounted and attached to the relay body 100. The relay body 100 includes a static contact 1 (as the static contact part) and a movable contact piece 2 (as the movable contact part) for realizing the connection or disconnection thereof. The relay body 100 also includes an outer housing 3, one end of the static contact 1 is exposed outside of the outer housing 3 and electrically connected to the external load, and the other end is inserted into the inner part of the outer housing 3, and the movable contact piece 2 is arranged inside the outer housing 3 and connected to an electromagnetic drive mechanism 4. The static contact 1 is provided with an internal thread, which can be used to be threadedly connected and fixed with the external terminal. The movable contact piece 2 is a bridge-type movable contact piece. Under the action of the electromagnetic drive mechanism 4, the movable contact piece 2 can move relatively close to or away from the static contact 1. When the movable contact piece 2 contacts two static contacts 1 at the same time, the load is connected. For the convenience of description, it is described that the static contact 1 is relatively the movable contact piece 2 is located above the movable contact piece 2, and the movable contact piece 2 is relatively located below the static contact 1.

The relay body 100 further includes a ceramic cover 6, which is fixedly arranged inside the outer housing 3 and covers the lower end of the static contact 1 and the movable contact piece 2 (i.e., covers the static contact 1, the movable contact piece 2, and the contacts therebetween) to form a contact chamber. The ceramic cover 6 isolates the contacts between the static contact 1 and the movable contact piece 2 from the outside air to obtain high voltage resistance performance, which can effectively ensure that the relay has low contact resistance, long life, and high reliability. When the relay is short-circuited, the arc resistance and high temperature resistance of the ceramic material can ensure, so that the circuit under the short-circuit arc is safe and reliable.

The outer housing 3 further includes a base 32 and a cover 31 which are connected to each other. The ceramic cover 6 is arranged inside the cover 31. The pyrotechnic actuator 5 is inserted from the outside of the ceramic cover 6 and fixedly connected to the ceramic cover 6, the lower end of the pyrotechnic actuator 5 extends into the contact chamber of the ceramic cover 6 to face the movable contact piece 2, and the cover 31 is then covered on the ceramic cover 6 and the pyrotechnic actuator 5 to complete the overall assembly of the relay. Referring to FIG. 15, the pyrotechnic actuator 5 is an independent modular construction, and its appearance is generally a columnar rotating body structure, a mounting hole 61 is opened at the upper end of the ceramic cover 6, and the lower end of the pyrotechnic actuator 5 passes through the mounting hole 61 to extend into the contact chamber. The pyrotechnic actuator 5 can be fixed on the ceramic cover 6 by welding, riveting, screwing, etc. In this embodiment, the pyrotechnic actuator 5 is fixed on the ceramic cover 6 by brazing. In addition, in this embodiment, the top surface of the cover 31 has through holes and a hollow cylindrical section for mounting and matching two static contacts 1 and one pyrotechnic actuator 5, so that the top ends of the two static contacts 1 can be exposed to the outer housing 3, and the outside of the pyrotechnic actuator 5 can be covered and protected. In addition, in order to improve electrical safety, a protective baffle is extended from both sides of the outer wall of the hollow cylindrical section in a direction perpendicular to the paper surface shown in the Fig. (not shown in the Fig. due to angle problems). In other embodiments, the pyrotechnic actuator 5 may also be fixedly connected to the outer housing 3, but in this embodiment, the pyrotechnic actuator 5 is fixedly connected to the ceramic cover 6 to simplify the assembly process. During final assembly, the pyrotechnic actuator 5 and the static contact 1 are fixedly assembled on the ceramic cover 6 and then the cover 31 is covered.

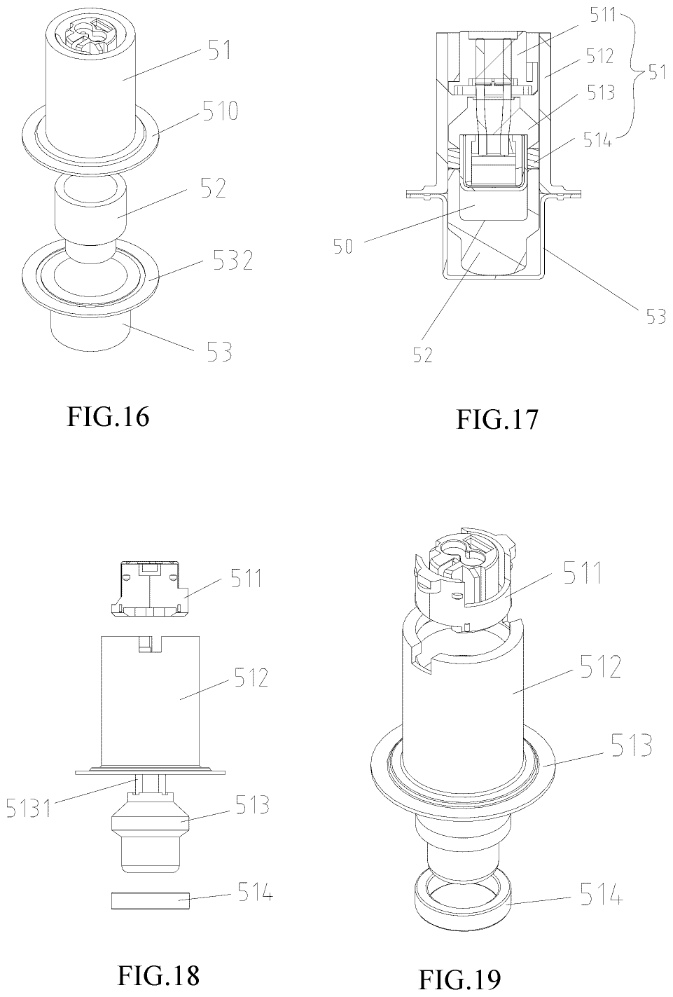

Referring to FIGS. 16-19, the pyrotechnic actuator 5 specifically includes an actuator 51, a piston 52 and a bottom shell 53. The actuator 51 and the bottom shell 53 are fixedly connected one above the other, and the piston 52 is accommodated between the actuator 51 and the bottom shell 53. The actuator 51 further includes a hollow actuator base 512 and a connector 511, an igniter 513 and the sealing ring 514 installed inside the actuator base 512. The actuator base 512 and the bottom shell 53 are fixedly connected to form the outer housing of the pyrotechnic actuator 5. The connector 511, the igniter 513, the sealing ring 514 and the piston 52 are sequentially arranged inside the outer housing from top to bottom, and the connector 511 is connected to the lead 5131 of the igniter 513. The connector 511 is fixedly connected to the outer housing by clamping. The sealing ring 514 is pressed into the inner wall of the actuator base 512 by interference fit, and the actuator base 512 presses the igniter 513 upwards and fixes it. The upper and lower ends of the piston 52 are respectively pressed by the sealing ring 514 and the bottom shell 53. The sealing ring 514 can play roles of moisture-proof and air-tight. The micro-deformation of the sealing ring 514 under pressure can further press the igniter 513 above and the piston 52 below to prevent vibration loosening.

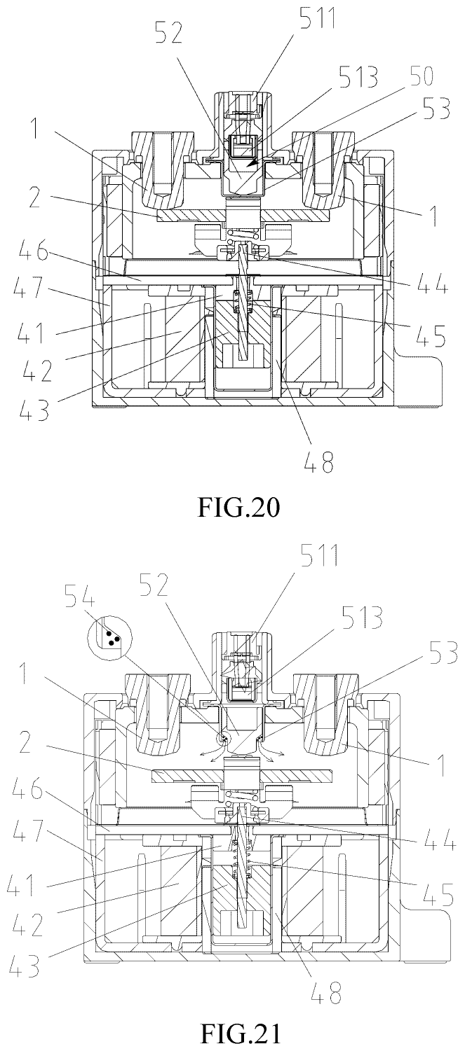

Referring to FIGS. 20-21, the connector 511 is used to fix the ignition lead of the monitoring excitation circuit to transmit the excitation electrical signal emitted by the monitoring excitation circuit to excite the igniter 513. The monitoring excitation circuit may emit an excitation electrical signal to be transmitted downward through the connector 511 after the monitoring current value (or current climbing rate) reaches a certain threshold value, and excite the igniter 513 to ignite. An air gap 50 is provided between the piston 52 and the igniter 513. After the igniter 513 ignites the gunpowder, high-pressure gas is generated in the air gap 50) (i.e., ignition is performed), pushing the piston 52 downward to break through the bottom shell 53, and then the piston 52 pushes the movable contact piece 2 downward to help the movable contact piece 2 disconnect with the contact with the static contact 1, so as to achieve the rapid disconnection of the relay.

The bottom shell 53 is a hollow cylindrical structure, and the piston 52 is a rotating body structure arranged inside the bottom shell 53 through the shaft hole, so that the bottom shell 53 can guide the piston 52, so that the piston 52 moves axially downward along the hollow cylindrical inner chamber of the bottom shell 53 after the igniter 513 is ignited.

In this embodiment, the pyrotechnic actuator 5 is a modular construction, which is independent from the relay body and can be produced separately and then fixedly installed on the relay. The production and transportation of the pyrotechnic actuator 5 are easy to control, the number of parts is small, and it is easy to assemble. The standardization of parts is also easier to achieve, so as to achieve the purpose of reducing weight, reducing costs and improving performance. In addition, the igniter 513 extends a lead 5131 to connect with the ignition lead of the monitoring excitation circuit through the connector 511, so that the gunpowder in the igniter 513 is far away from the lead-out end of the ignition lead, the temperature rise is low; and the temperature resistance requirement of the gunpowder is reduced.

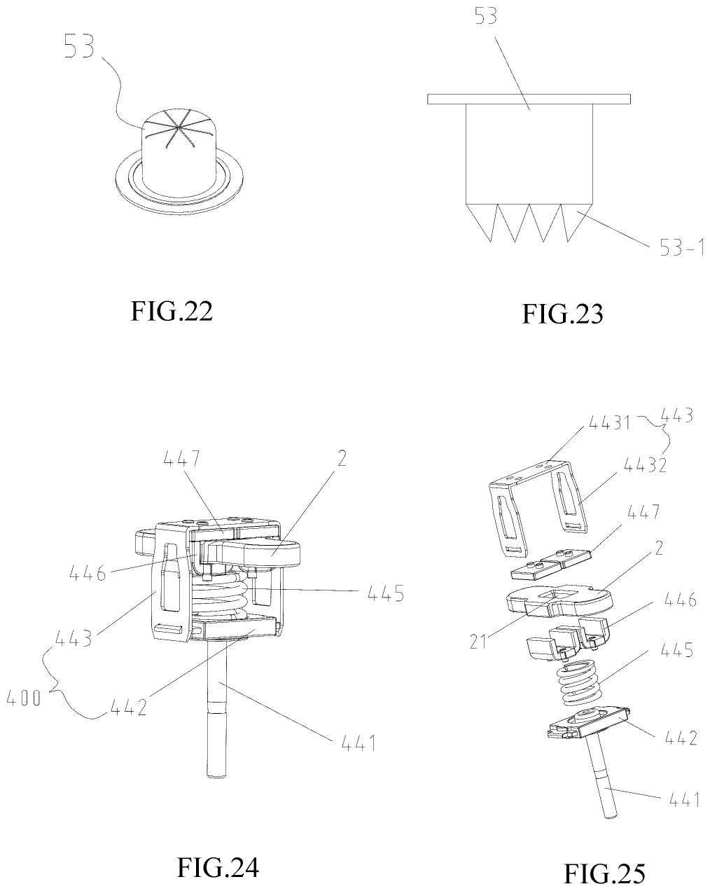

Referring to FIGS. 22-23, in this embodiment, a [symbol] -shaped staggered crevice is provided at the bottom of the bottom shell 53. When the piston 52 impacts the bottom shell 53 downward, the bottom of the bottom shell 53 expands outward from the intersection of the [symbol] -shaped crevice to form a sharp-toothed non-return portion 53-1 that abuts against the circumference or end of the piston 52 (if the piston 52 does not completely rush out of the bottom shell 53, the non-return portion 53-1 abuts against the circumference of the piston 52 to stop the piston 52; if the piston 52 completely rushes out of the bottom shell 53, the non-return portion 53-1 abuts against the end of the piston 52 to stop the piston 52) to prevent the piston 52 from rebounding. That is to say, under the non-return structure of the [symbol] -shaped staggered crevice of the present embodiment, the piston 52 can be squeezed out from the bottom of the bottom shell 53, but cannot rebound due to the stopper of the non-return portion 53-1, and the piston 52 can be stuck in time, reducing the energy loss caused by the rebound of the piston 52. At the same time, after the piston 52 is stopped, the head of the piston 52 firmly presses against the movable contact piece, avoiding the possibility of the movable contact and the static contact closing again.

The crevice at the bottom of the bottom shell 53 may be a [symbol] -shaped in the present embodiment or in other shapes, such as a cross-shaped. Any crevice shape that can expand outwards after the bottom of the bottom shell 53 is impacted is a feasible solution.

It is worth noting that the pyrotechnic actuator with the non-return structure of this embodiment may also not be installed on the relay body as an independent modular construction, but may be integrated inside the relay and fixedly integrated with the relay as that in the prior art. The pyrotechnic actuator with the non-return structure can significantly improve the electrical safety performance of the relay, which is not necessarily related to the structure and installation method of the pyrotechnic actuator.

In this embodiment, the pyrotechnic actuator 5 is applied to a ceramic sealed relay. Specifically, the pyrotechnic actuator 5 is welded to the ceramic cover 3. The welding has good tightness, the sealing and vibration resistance of the pyrotechnic actuator 5 are better, and the outer housing of the pyrotechnic actuator 5 is simpler to form, and the product height is lower. In other embodiments, the pyrotechnic actuator 5 can also be applied to the relay of other structures, as long as a mounting hole (such as the mounting hole 61 of this embodiment) is set on the relay body for the pyrotechnic actuator 5 to be inserted, and the pyrotechnic actuator 5 is attached to the relay by a fixed connection method. The pyrotechnic actuator 5 can also be fixed to the relay body by a detachable connection (such as a screw connection), so that the pyrotechnic actuator 5 can be quickly replaced according to input requirements.

As shown in FIG. 21, an arc-extinguishing medium 54 is also provided in the bottom shell 53 of the pyrotechnic actuator 5. When the pyrotechnic actuator 5 is excited, the piston 52 is used to break through the bottom shell 53 downwards to release the arc-extinguishing medium 54 into the contact chamber of the ceramic cover 6, to extinguish the arc generated in the contact gap between the static contact 1 and the movable contact piece 2, which further accelerates the arc extinguishing ability when the contacts are disconnected and improves the short-circuit safety of the product. In this embodiment, the arc-extinguishing medium 54 is quartz, sand. Since the gas at the lower end of the pyrotechnic actuator 5 expands rapidly after ignition and explosion, the arc-extinguishing medium 54 stored in the bottom shell 53 or the piston 52 can be evenly spread in the contact chamber along with the explosion gas very quickly, and is not limited by the outer shape of the static contact 1 and the movable contact piece 2 and the inner contour of the contact chamber to the greatest extent, and can directly play the arc-extinguishing effect in a very short time. In this embodiment, the movable contact piece 2 is a bridge-type movable contact piece, and the static contact 1 is set at two ends of the bridge-type movable contact piece. The pyrotechnic actuator 5 is arranged at one side of the middle section of the movable contact piece 2. After the pyrotechnic actuator 5 is ignited and exploded, the expansion gas will be blocked by the bridge-type movable contact piece, which makes the airflow go to two ends of the bridge-type movable contact piece, so that the arc-extinguishing medium 54 can reach the area between the static contact 1 and the movable contact piece 2 more directly.

The electromagnetic drive mechanism 4 is used to drive the movable contact piece 2 to move. Referring to FIGS. 20-21, the electromagnetic drive mechanism 4 specifically includes a static iron core 41, a coil 42, a movable iron core 43, a push rod assembly 44 and a reset spring 45, as well as a first yoke 46, a second yoke 47 and a magnetic cylinder 48 for transmitting magnetic lines of flux and improving the utilization rate of magnetic energy. The lower end of the push rod assembly 44 is fixedly connected to the movable iron core 43, and the upper end is linked to the movable contact piece 2. One end of the reset spring 45 acts on the static iron core 41, and the other end acts on the movable iron core 43. When the coil 42 is powered on, the static iron core 41 attracts the movable iron core 43 to move upward, so that the push rod 44 pushes the movable contact piece 2 upward; When the coil 42 is powered off, the electromagnetic drive mechanism 4 is reset under the elastic force of the reset spring 45. The electromagnetic drive mechanism 4 is a common direct-moving magnetic circuit structure, and its operating principle is not described in detail in this embodiment.

Referring to FIGS. 24-25, the push rod assembly 44 includes a push rod 441, a spring seat 442 and a U-shaped bracket 443. The push rod 441 is used to output the driving force of the electromagnetic drive mechanism 4, its lower end is fixedly connected to the movable iron core 43, and its upper end is fixedly connected to the spring seat 442. The U-shaped bracket 443 is a sheet structure including a top wall 4431 horizontally placed above the spring seat 442 and two side walls 4432 connected to both ends of the top wall 4431 and extending downward. The lower ends of the two side walls 4432 are fixedly connected to both ends of the spring seat 442, so that the spring seat 442 and the U-shaped bracket 443 are connected to form a square hollow restraint frame 400. The lower end of an over-travel spring 445 abuts against the spring seat 442, and the movable contact piece 2 passes through the restrain frame 400 and abuts against the top wall 4431 under the elastic force of the over-travel spring 445, so that the over-travel spring 445 and the movable contact piece 2 are stably installed in the restrain frame 400 by means of the elastic force of the over-travel spring 445. In addition, when the push rod assembly 44 pushes the movable contact piece 2 upward to contact the static contact 1, the spring seat 442 can further compress the over-travel spring 445, thereby realizing the over-travel of the contact when the relay is in the conducted state.

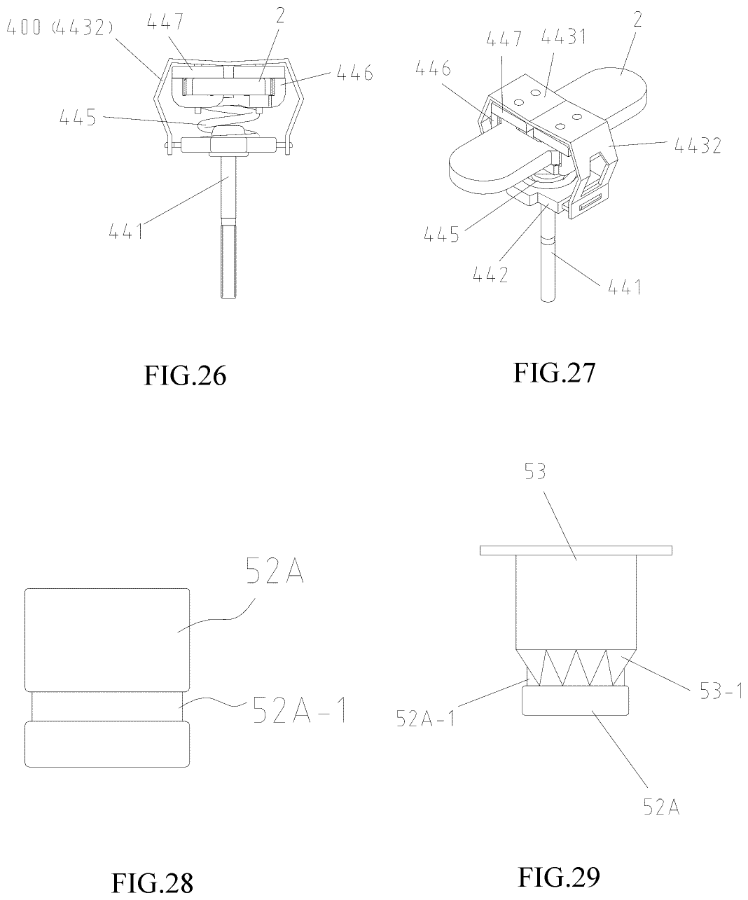

Referring to FIGS. 26-27, the present embodiment adopts the spring seat 442 and the U-shaped bracket 443 forming the restrain frame 400. When the pyrotechnic actuator 5 is excited, the piston 52 impacts downward on the restrain frame 400, so that the push rod assembly 44 and the movable contact piece 2 move downward. After the spring seat 442 is stopped by the internal structure of the relay, the over-travel spring 445 is further compressed under the impact force of the piston 52. The two side walls 4432 of the U-shaped bracket 443 are compressed and bent, resulting in plastic deformation, so that the entire restrain frame 400 is flattened and cannot be restored, so that the height of the entire push rod assembly 44 and the movable contact piece 2 is further lowered. Since the U-shaped bracket 443 is straddled above the plate-shaped movable contact piece 2, it can restrain the movable contact piece 2 from rebounding toward the static contact 1. Moreover, due to downward impact of the piston 52, the restraint frame 400 is compressed and flattened, which can further widen the contact gap between the movable contact piece 2 and the static contact 1, thereby improving the short circuit safety. From another perspective, since the restraint frame 400 formed by the spring seat 442 and the U-shaped bracket 443 in this embodiment can be compressed and flattened, compared with other solutions in which the push rod assembly cannot be compressed and flattened, when the push rod assembly 44 and the movable contact piece 2 in this embodiment are impacted by the piston 52, only a smaller downward movement distance (adding the compressed space after the restraint frame 400 is flattened) is required to ensure that a sufficient contact gap is formed, so the height space of the contact chamber of the ceramic cover 6 can also be appropriately set to be smaller, which can be consistent with the specifications of the relay without the pyrotechnic actuator 5 (the existing relay with the pyrotechnic actuator 5 needs to increase the height space of the contact chamber), so that the height volume of the entire relay can also be reduced.

The U-shaped bracket 443 is made of materials that do not recover deformation, such as stainless steel or low carbon steel. In addition, in this embodiment, the side wall 4432 is a hollow sheet structure, so that the side wall 4432 is more easily bent under pressure.

In this embodiment, the restraint frame 400 is adopted to install the movable contact piece 2 and realize the rebound recovery of the movable contact piece 2 toward the static contact 1. Other restraint parts can also be used to replace the restraint frame 400 in other embodiments. For example, the movable contact piece 2 is fixedly connected to the end of a support rod, but the support rod body is designed to be a structure that can accept impact and produce axial compression and does not recover deformation. As long as the restraint part is configured to be able to restrain the movable contact piece 2 to return toward the static contact 1 and is coupled and assembled with the movable contact piece 2, it is feasible.

The non-return structure of the piston 52 is provided in this embodiment, on the one hand, the non-return structure can make the piston 52 be stuck in time after rushing out of the bottom shell 53, and the piston 52 will not rebound due to impact, and the restrain frame 400) can prevent the movable contact piece 2 from rebounding, and both can avoid the re-contact of the movable contact and the static contact, and realize double insurance; On the other hand, since the non-return structure prevents the piston 52 from rebounding, thereby reducing the energy loss caused by the rebound of the piston 52, most of the kinetic energy of the piston 52 can act on the restrain frame 400, ensuring that the restrain frame 400 can be crushed flattened by the impact. Since the energy loss of the rebound of the piston 52 is reduced, the impact force requirement of the piston 52 in this embodiment can be reduced, so that the amount of gunpowder in this embodiment can also be reduced, and the safety performance is improved. This embodiment uses a relay structure to illustrate the functions and effects of the pyrotechnic actuator 5 and the push rod assembly 44. In addition to the relay, the same structure can also be applied to other switch apparatuses, such as contactors.

### The Seventh Embodiment

This embodiment proposes a relay, which has a structure similar to the relay of embodiment 6, and also includes a bottom shell 53 with a [symbol] -shaped crevice at the bottom, but the difference lies in the structure of the piston of this embodiment. As shown in FIGS. 28-29, the piston 52A of this embodiment is provided with a neck portion 52A-1 with a reduced diameter. When the piston 52A breaks through the bottom shell 53 downward, the bottom of the bottom shell 53 expands outward from the intersection of the [symbol] -shaped crevice to form a sharp tooth-shaped non-return portion 53-1. When the piston 52A impacts the movable contact piece and rebounds, the lower end step of the neck portion 52A-1 is resisted by the non-return portion 53-1 and is limited.

In this embodiment, the piston 52A is provided with a neck portion 52A-1 with a reduced diameter, so that the piston 52A can abut against the lower end step of the neck portion 52A-1 to produce a non-return effect on the piston 52A, so that the piston 52A of this embodiment can be stably abutted against the non-return portion 53-1 to prevent it from returning even if it does not completely rush out of the bottom shell 53. Therefore, the stroke and impact force requirement of the piston 52A of this embodiment can be reduced, so that the amount of gunpowder in this embodiment can also be reduced, thereby improving safety performance.

### The Eighth Embodiment

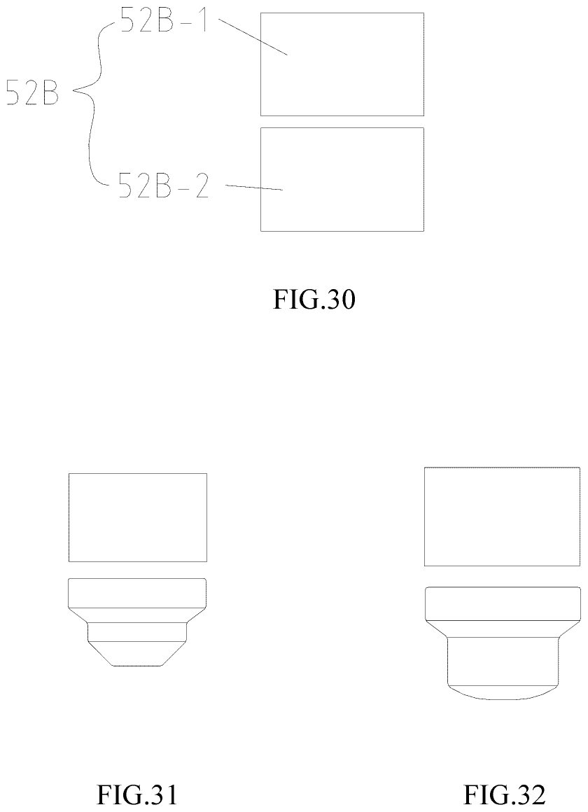

This embodiment proposes a relay, which has a structure similar to the relay of the sixth embodiment, and also includes a bottom shell 53 with a [symbol] -shaped crevice at the bottom, but the difference lies in the structure of the piston of this embodiment. Referring to FIG. 30, in this embodiment, the piston 52B is divided into two independent sections in the vertical direction, namely the upper piston 52B-1 and the lower piston 52B-2. When the pyrotechnic actuator is not excited, the upper piston 52B-1 and the lower piston 52B-2 are stacked up and down. When the pyrotechnic actuator is excited, the lower piston 52B-2 rushes out of the bottom shell 53c, and the upper piston 52B-1 remains in the bottom shell 53c, so that the non-return portion 53c-1 of the bottom shell 53c resists and limits the end of the lower piston 52B-2. This embodiment is similar to the seventh embodiment, both of which form a radial step difference structure on the piston. The radial step difference of the piston is formed by a reduced diameter part in the seventh embodiment, while in this embodiment, the radial step difference is formed by dividing the piston into two independent sections, the effect can be seen in the seventh embodiment.

### The Ninth Embodiment

This embodiment proposes a relay, which has a structure similar to the relay of the eighth embodiment, and also includes a bottom shell 53 with the crevice in the shape [symbol] -shaped at the bottom and the piston divided into two sections. The only difference is that: in this embodiment, the piston is a shape that contracts from top to bottom (i.e., in the direction in which the piston breaks through the bottom shell). The force application area of the piston in this embodiment is reduced, and the force acting on the bottom shell and the movable contact piece is enhanced, so that the bottom shell can be broken faster and the movable contact piece can be quickly pushed to be disconnected from the static contact. The contraction shape of the lower end of the piston can be realized by using a conical contraction, a step contraction, or a contraction structure combining a conical shape and a step shape. The piston with a contracted lower end as shown in FIGS. 31 and 32 is feasible.

In addition, when the existing pyrotechnic actuator is used in the relay with a larger anti-short circuit ability, the required explosion impact force is also greater, so the amount of gunpowder carried is also greater, which is not conducive to safety control during production and assembly.

Therefore, the present disclosure also proposes a switch apparatus having a pyrotechnic actuator with an optimized structure.

The present disclosure adopts following technical solutions:

The present disclosure proposes a switch apparatus having a pyrotechnic actuator, including a switch body and a pyrotechnic actuator arranged on the switch body. The switch body includes a direct-acting electromagnetic drive mechanism, and a fixedly arranged static contact part and a movable contact part to perform a switch function. The direct-acting electromagnetic drive mechanism includes a push rod assembly, the movable contact part is assembled in the push rod assembly through the elastic piece to achieve contact with the static contact part. The switch apparatus also includes at least one group of the magnetic conduction ring assembly, the magnetic conduction ring assembly includes an upper magnet and a lower magnet arranged opposite to each other, the upper magnet is fixedly connected to the upper end of the push rod assembly, the lower magnet is fixedly connected to the movable contact part. The pyrotechnic actuator includes a pushing medium for performing downward movement, the pushing medium corresponds to the position above the push rod assembly.

The pushing medium is a high-pressure gas generated by the ignition of the pyrotechnic actuator, or the pushing medium is the piston.

In order to improve the anti-short circuit ability of the switch apparatus, in an embodiment, the magnetic conduction ring assembly is provided with n groups, n≥2.

Based on manufacturing and installation considerations, in an embodiment, the upper magnet has a linear structure and is fixedly placed horizontally above the movable contact part, the lower magnet has a U-shaped structure, the lower magnet and the movable contact part are fixedly connected and semi-surround at least a portion of the current carrying conductor of the movable contact part, and the opening of the lower magnet in U-shaped is arranged toward the upper magnet, so that the upper magnet and the lower magnet form a magnetic circuit.

Based on manufacturing and installation considerations, in one embodiment, the push rod assembly includes a restraint frame, a movable contact part passes through the restraint frame, an elastic piece is fixedly installed inside the restraint frame, and the movable contact part is pushed toward the upper end of the restraint frame by the elastic force of the elastic piece, the upper magnet is fixedly connected to the inner side of the top of the restraint frame and is arranged above the movable contact part, and after the restrain frame moves upward to make the movable contact part and the static contact part abut against each other, the direct-acting electromagnetic drive mechanism drives the restrain frame to continue to move upward to compress the elastic piece, and to create a certain magnetic air gap between the upper magnet and the lower magnet.

In order to reduce the elastic force demand of the over-travel elastic piece, and thus reduce the gunpowder amount of the pyrotechnic actuator, in an embodiment, when the movable contact part and the static contact part abut against each other, the elastic force of the elastic piece is less than the maximum electro-dynamic repulsion force between the movable contact part and the static contact part.

In order to facilitate manufacturing, transportation and assembly of the pyrotechnic actuator, in an embodiment, the pyrotechnic actuator is an independent modular construction fixedly installed on the switch body from the outside of the switch body. The pyrotechnic actuator generates an explosive impact force by igniting gunpowder, forcing the movable contact part to move away from the static contact part to quickly disconnect the switch apparatus.

In one embodiment, based on manufacturing and installation considerations, the switch body includes a ceramic cover, a ceramic cover at least surrounds the static contact part and the movable contact part and the contact parts with each other to form a contact chamber, the ceramic cover is provided with a mounting hole, one end of the pyrotechnic actuator passes through the mounting hole and extends into the contact chamber to be arranged opposite to one side of the movable contact part.

Based on manufacturing and installation considerations, in an embodiment, the pyrotechnic actuator includes an actuator, a bottom shell and a piston serving as the pushing medium, the actuator and the bottom shell are joined and fixed, the bottom shell is of a hollow structure, the piston is cooperatively installed in the bottom shell, the bottom shell passes through the mounting hole and extends into the contact chamber and toward the movable contact part, when the pyrotechnic actuator is excited, the actuator ignites gunpowder and pushes the piston through the bottom shell through the gas, and the piston moves toward the movable contact part under the guidance of the bottom shell, thereby pushing the movable contact part away from the static contact part.

In order to improve the arc extinguishing ability of the switch apparatus, in an embodiment, an arc-extinguishing medium is further stored in the piston or the bottom shell. After the piston breaks through the bottom shell, the arc-extinguishing medium is released into the contact chamber through the rupture of the piston or the bottom shell to extinguish the arc between the static contact part and the movable contact part.

The switch apparatus is a direct current high voltage relay.

The present disclosure has following beneficial effects: the present disclosure further provides the magnetic conduction ring assembly on the basis of the switch apparatus having the pyrotechnic actuator, firstly, the anti-short circuit ability of the switch apparatus can be improved, and the switch apparatus can be applied to the occasions with high anti-short circuit requirements; secondly, the requirement of the over-travel spring on the contact pressure of the movable contact piece can be reduced, and the over-travel elastic piece with a small elastic coefficient k value can be selected, or the travel amount of the over-travel elastic piece can be reduced, thereby reducing the amount of gunpowder required by the pyrotechnic actuator and improving the reliability of the pyrotechnic actuator. At the same time, the contact holding force of the movable iron core in the electromagnetic drive mechanism can be reduced accordingly, and the diameter of the movable iron core, the elastic force of the reset spring, the attraction force of the coil, etc. can be reduced, thereby further reducing the amount of gunpowder required by the pyrotechnic actuator and improving the reliability of the pyrotechnic actuator. Thirdly, it can accelerate the disconnection of the contacts and improve electrical safety.

The present disclosure is now further described in conjunction with the accompanying drawings and specific implementation methods.

### The Tenth Embodiment

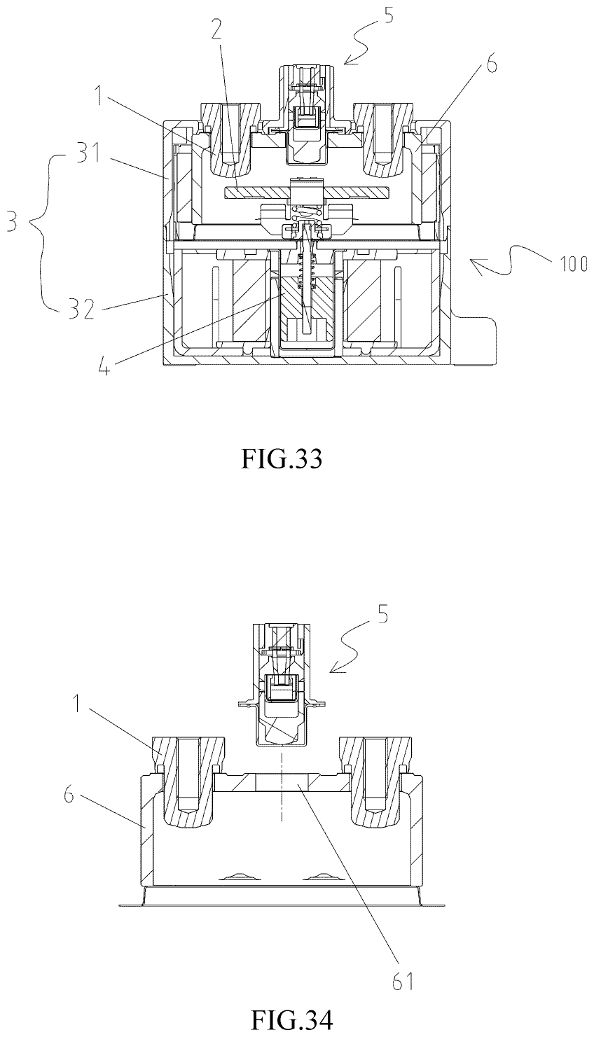

Referring to FIGS. 33-34, as an embodiment of the present disclosure, a relay having a pyrotechnic actuator is provided, which includes a relay body 100 and a pyrotechnic actuator 5 mounted and attached to the relay body 100. The relay body 100 includes a static contact 1 (as the static contact part) and a movable contact piece 2 (as the movable contact part) for realizing the connection or disconnection thereof. The relay body 100 also includes an outer housing 3, one end of the static contact 1 is exposed outside of the outer housing 3 and electrically connected to the external load, and the other end is inserted into the inner part of the outer housing 3, and the movable contact piece 2 is arranged inside the outer housing 3 and connected to an electromagnetic drive mechanism 4. The static contact 1 is provided with an internal thread, which can be used to be threadedly connected and fixed with the external terminal. The movable contact piece 2 is a bridge-type movable contact piece. Under the action of the electromagnetic drive mechanism 4, the movable contact piece 2 can move relatively close to or away from the static contact 1. When the movable contact piece 2 contacts two static contacts 1 at the same time, the load is connected. For the convenience of description, it is described that the static contact 1 is relatively above the movable contact piece 2, and the movable contact piece 2 is relatively below the static contact 1.

The relay body 100 further includes a ceramic cover 6, which is fixedly arranged inside the outer housing 3 and covers the lower end of the static contact 1 and the movable contact piece 2 (i.e., covers the static contact 1, the movable contact piece 2 and the contact therebetween) to form a contact chamber. The ceramic cover 6 isolates the contacts between the static contact 1 and the movable contact piece 2 from the outside air to obtain high voltage resistance performance, which can effectively ensure that the relay has low contact resistance, long life, and high reliability. When the relay is short-circuited, the arc resistance and high temperature resistance of the ceramic material can ensure, so that the circuit under the short-circuit arc is safe and reliable.

The outer housing 3 further includes a base 32 and a cover 31 which are connected to each other. The ceramic cover 6 is arranged inside the cover 31, the pyrotechnic actuator 5 is inserted from the outside of the ceramic cover 6 and fixedly connected to the ceramic cover 6, the lower end of the pyrotechnic actuator 5 extends into the contact chamber of the ceramic cover 6 to face the movable contact piece 2, and the cover 31 is then covered on the ceramic cover 6 and the pyrotechnic actuator 5 to complete the overall assembly of the relay. Referring to FIG. 34, the pyrotechnic actuator 5 is an independent modular construction, and its appearance is generally a columnar rotating body structure, a mounting hole 61 is opened at the upper end of the ceramic cover 6, and the lower end of the pyrotechnic actuator 5 passes through the mounting hole 61 to extend into the contact chamber. The pyrotechnic actuator 5 can be fixed on the ceramic cover 6 by welding, riveting, screwing, etc. In this embodiment, the pyrotechnic actuator 5 is fixed on the ceramic cover 6 by brazing. In addition, in this embodiment, the top surface of the cover 31 has through holes and a hollow cylindrical section for mounting and matching two static contacts 1 and one pyrotechnic actuator 5, so that the top ends of the two static contacts 1 can be exposed to the outer housing 3, and the outside of the pyrotechnic actuator 5 can be covered and protected. In addition, in order to improve electrical safety, a protective baffle (not shown in the Figure due to angle problems) is extended from both sides of the outer wall of the hollow cylindrical section in a direction perpendicular to the paper surface. In other embodiments, the pyrotechnic actuator 5 may also be fixedly connected to the outer housing 3, but in this embodiment, the pyrotechnic actuator 5 is fixedly connected to the ceramic cover 6 to simplify the assembly process. During final assembly, the pyrotechnic actuator 5 and the static contact 1 are fixedly assembled on the ceramic cover 6 and then the cover 31 is covered.

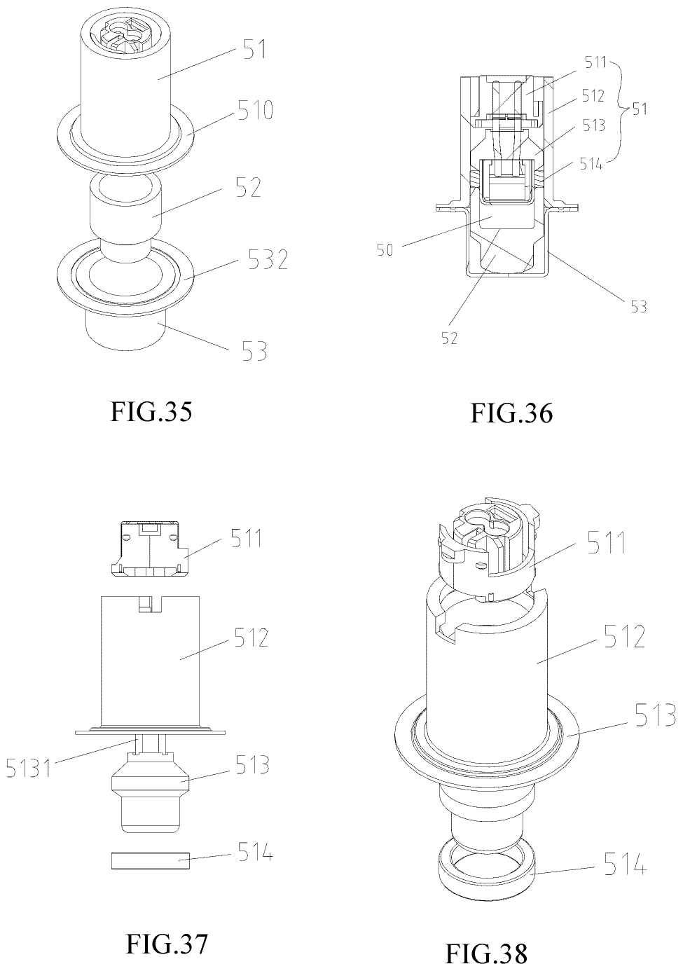

Referring to FIGS. 35-38, the pyrotechnic actuator 5 specifically includes an actuator 51, a piston 52 (as the pushing medium) and a bottom shell 53. The actuator 51 and the bottom shell 53 are fixedly connected one above and one below, and the piston 52 is accommodated between the actuator 51 and the bottom shell 53. The actuator 51 further includes a hollow actuator base 512, and a connector 511, an igniter 513 and a sealing ring 514 installed inside the actuator base 512. The actuator base 512 is a cylindrical structure, and a first flange 510 is provided at the lower end thereof. The bottom shell 53 is also a hollow cylindrical structure. A second flange 532 is provided at the upper end of the bottom shell 53. The first flange 510 and the second flange 532 are connected and fixed (such as welding, riveting, or screwing) to achieve the connection and fixation of the actuator 51 and the bottom shell 53. The lower end of the bottom shell 53 extends into the contact chamber of the ceramic cover 6, and the second flange 532 is brazed and fixed on the ceramic cover 6 to achieve the fixed connection between the pyrotechnic actuator 5 and the ceramic cover 6. As shown in FIG. 36, an annular rib 531 is provided on the side of the second flange 532 facing the ceramic cover 6. The provision of the annular rib 531 can further increase the stability of the brazing of the second flange 532 and the ceramic cover 6. In addition, since the first flange 510 and the second flange 532 form an outwardly expanded diameter portion to further seal the mounting hole 61, the airtightness of the ceramic cover 6 can be ensured.

In this embodiment, the actuator base 512 and the bottom shell 53 are fixedly connected to form the outer housing of the pyrotechnic actuator 5. The connector 511, the igniter 513, the sealing ring 514 and the piston 52 are sequentially arranged inside the outer housing from top to bottom, and the connector 511 is connected to the lead 5131 of the igniter 513. The connector 511 is fixedly connected to the outer housing by clamping. The sealing ring 514 is pressed into the inner wall of the actuator base 512 by interference fit, and the actuator base 512 presses the igniter 513 upwards and fixes it. The upper and lower ends of the piston 52 are respectively pressed by the sealing ring 514 and the bottom shell 53. The sealing ring 514 can play roles of moisture-proof and air-tight. The micro-deformation of the sealing ring 514 under pressure can further press the igniter 513 above and the piston 52 below to prevent vibration loosening.

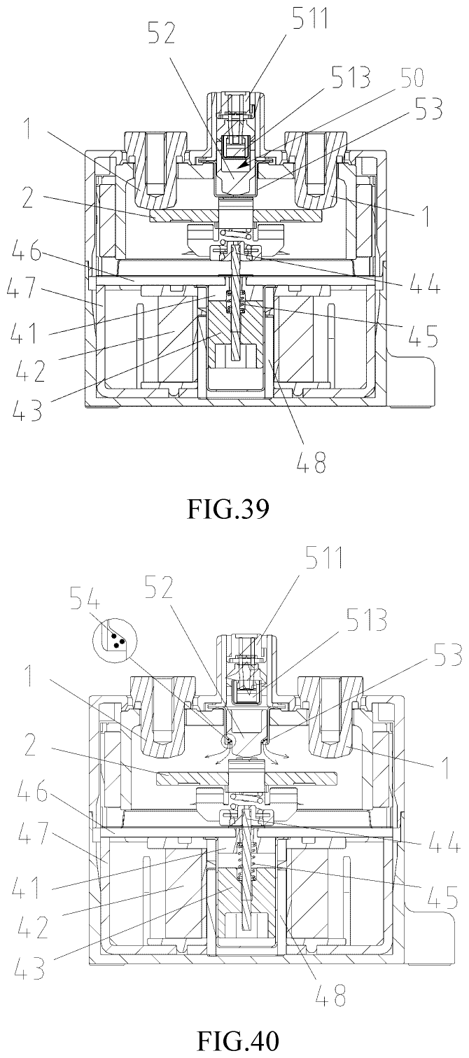

Referring to FIGS. 39-40, the connector 511 is used to fix the ignition lead of the monitoring excitation circuit to transmit the excitation electrical signal emitted by the monitoring excitation circuit to excite the igniter 513. The monitoring excitation circuit may emit an excitation electrical signal to be transmitted downward through the connector 511 after the monitoring current value (or current climbing rate) reaches a certain threshold value, and excite the igniter 513 to ignite. An air gap 50 is provided between the piston 52 and the igniter 513. After the igniter 513 ignites the gunpowder, high-pressure gas is generated in the air gap 50 (i.e., ignition is performed), pushing the piston 52 downward to break through the bottom shell 53, and then the piston 52 pushes the movable contact piece 2 downward to help the movable contact piece 2 disconnect with the contact with the static contact 1, so as to achieve the rapid disconnection of the relay.

The bottom shell 53 is a hollow cylindrical structure, and the piston 52 is a rotating body structure arranged inside the bottom shell 53 through the shaft hole, so that the bottom shell 53 can guide the piston 52, so that the piston 52 moves axially downward along the hollow cylindrical inner chamber of the bottom shell 53 after the igniter 513 is ignited.

In this embodiment, the piston 52 is used to execute the downward movement of the pyrotechnic actuator. In other embodiments, the pyrotechnic actuator may not be provided with the piston, and simply relies on the igniter 513 to ignite the gunpowder to generate high-pressure gas to break through the bottom shell 53 and push the movable contact piece 2. In other words, the pushing medium used to realize the downward pushing of the movable contact piece 2 by the pyrotechnic actuator can be either the high-pressure gas itself or the piston 52.

In this embodiment, the pyrotechnic actuator 5 is a modular construction, which is independent from the relay body and can be produced separately and then fixedly installed on the relay. The production and transportation of the pyrotechnic actuator 5 are easy to control, the number of parts is small, and it is easy to assemble. The standardization of parts is also easier to achieve, so as to achieve the purpose of reducing weight, reducing costs and improving performance. In addition, the igniter 513 extends a lead 5131 to connect with the ignition lead of the monitoring excitation circuit through the connector 511, so that the gunpowder in the igniter 513 is far away from the lead-out end of the ignition lead, the temperature rise is low, and the temperature resistance requirement of the gunpowder is reduced.

In this embodiment, the pyrotechnic actuator 5 is applied to a ceramic sealed relay. Specifically, the pyrotechnic actuator 5 is welded to the ceramic cover 3. The welding has good tightness, the sealing and vibration resistance of the pyrotechnic actuator 5 are better, and the outer housing of the pyrotechnic actuator 5 is simpler to form, and the product height is lower. In other embodiments, the pyrotechnic actuator 5 can also be applied to the relay of other structures, as long as a mounting hole (such as the mounting hole 61 of this embodiment) is set on the relay body for the pyrotechnic actuator 5 to be inserted, and the pyrotechnic actuator 5 is attached to the relay by a fixed connection method. The pyrotechnic actuator 5 can also be fixed to the relay body by a detachable connection (such as a screw connection), so that the pyrotechnic actuator 5 can be quickly replaced according to input requirements.

As shown in FIG. 40, an arc-extinguishing medium 54 is also provided in the bottom shell 53. When the pyrotechnic actuator 5 is excited, the piston 52 is used to break through the bottom shell 53 downwards, so that the arc-extinguishing medium 54 is released in the contact chamber of the ceramic cover 6, to extinguish the arc generated in the contact gap between the static contact 1 and the movable contact piece 2, so as to further accelerate the arc extinguishing ability when the contacts are disconnected, and improve the short-circuit safety of the product. In this embodiment, the arc-extinguishing medium 54 is quartz sand. In addition to storing the arc-extinguishing medium 54 in the bottom shell 53. In other embodiments, the arc-extinguishing medium 54 can also be stored in the piston 52, for example, the lower end (impact part) of the piston 52 is set to a fragile columnar structure with a central chamber, and when the piston 52 hits the movable contact piece 2, the lower end of the piston 52 is broken due to the impact, and the crevice is generated, so that the arc-extinguishing medium 54 is released. Since the gas at the lower end of the pyrotechnic actuator 5 expands rapidly after ignition and explosion, the arc-extinguishing medium 54 stored in the bottom shell 53 or the piston 52 can be evenly spread in the contact chamber along with the explosion gas very quickly, and is not limited by the outer shape of the static contact 1 and the movable contact piece 2 and the inner contour of the contact chamber to the greatest extent, and can directly play the arc extinguishing effect in a very short time. In this embodiment, the movable contact piece 2 is a bridge-type movable contact piece, and the static contact 1 is set on two ends of the bridge-type movable contact piece, the pyrotechnic actuator 5 is arranged at one side of the middle section of the movable contact piece 2. After the pyrotechnic actuator 5 is ignited and exploded, the expansion gas will be blocked by the bridge-type movable contact piece, which makes the airflow go to two ends of the bridge-type movable contact piece, so that the arc-extinguishing medium 54 can reach the area between the static contact 1 and the movable contact piece 2 more directly.

Referring to FIGS. 39-40, the electromagnetic drive mechanism 4 is used to drive the movable contact piece 2 to move. The electromagnetic drive mechanism 4 specifically includes a static iron core 41, a coil 42, a movable iron core 43, a push rod assembly 44 and a reset spring 45, as well as a first yoke 46, a second yoke 47 and a magnetic cylinder 48 for transmitting magnetic lines of flux and improving the utilization rate of magnetic energy. The lower end of the push rod assembly 44 is fixedly connected to the movable iron core 43, and the upper end is linked to the movable contact piece 2. One end of the reset spring 45 acts on the static iron core 41, and the other end acts on the movable iron core 43. When the coil 42 is powered on, the static iron core 41 attracts the movable iron core 43 to move upward, so that the push rod 44 pushes the movable contact piece 2 upward; When the coil 42 is powered off, the electromagnetic drive mechanism 4 is reset under the elastic force of the reset spring 45. The electromagnetic drive mechanism 4 is a common direct-moving magnetic circuit structure, and its operating principle is not described in detail in this embodiment.

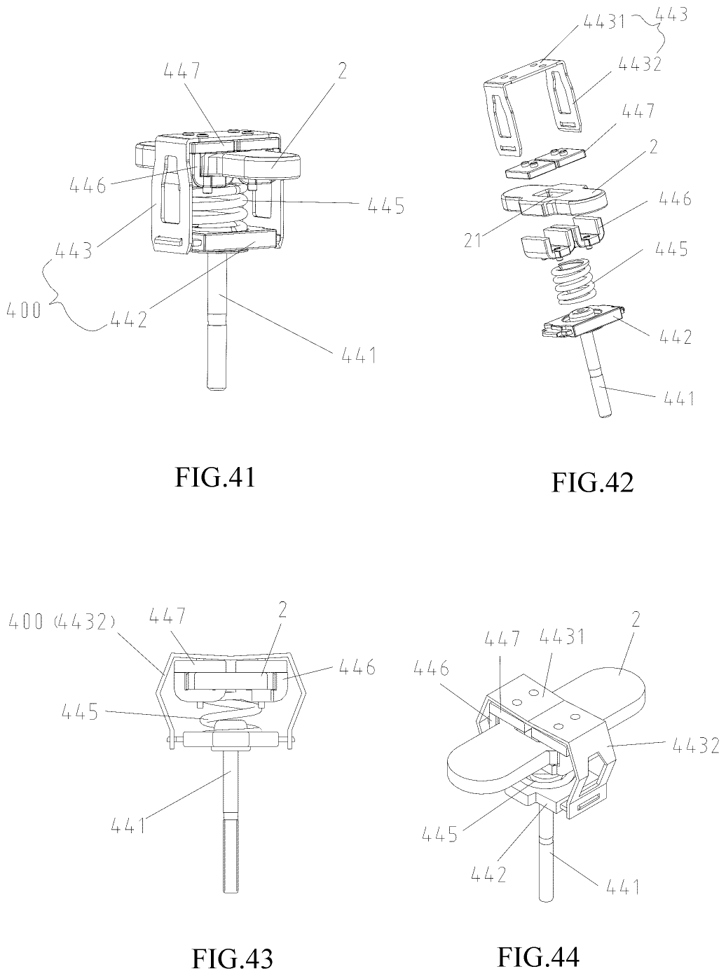

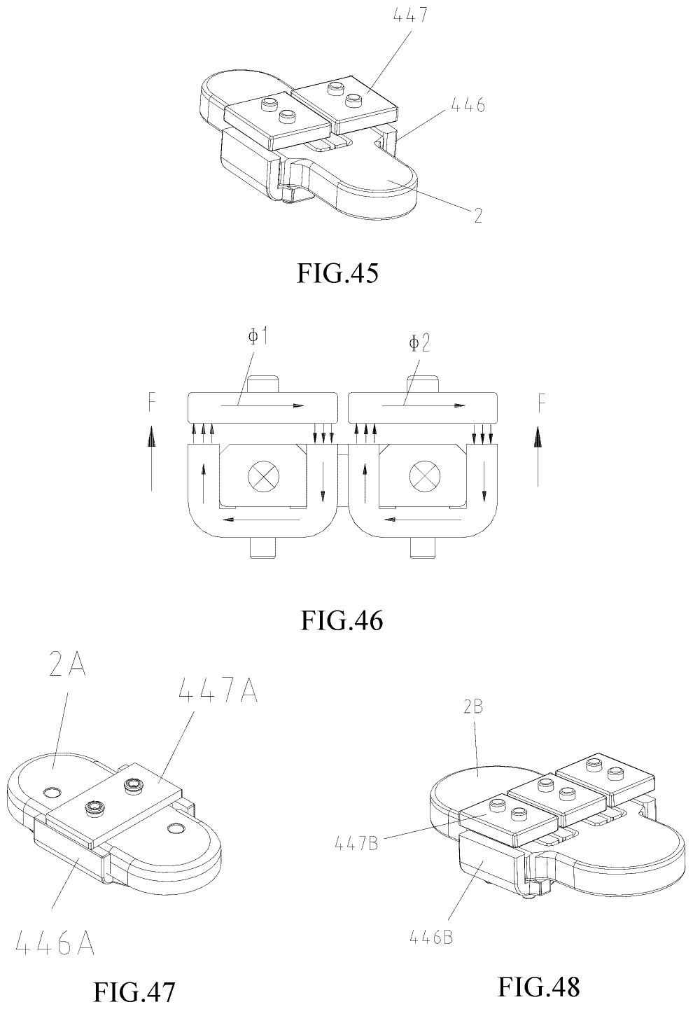

Referring to FIGS. 41-42, the push rod assembly 44 includes a push rod 441, a spring seat 442 and a U-shaped bracket 443. The push rod 441 is used to output the driving force of the electromagnetic drive mechanism 4, its lower end is fixedly connected to the movable iron core 43 (refer to FIG. 40) and its upper end is fixedly connected to the spring seat 442. The U-shaped bracket 443 is a sheet structure, including a top wall 4431 disposed above the spring seat 442 and two side walls 4432 connected to both ends of the top wall 4431 and extending downward. The lower ends of the two side walls 4432 are fixedly connected to both ends of the spring seat 442, so that the spring seat 442 and the U-shaped bracket 443 are connected to form a square hollow restraint frame 400. The lower end of the over-travel spring 445 (as the over-travel elastic piece) abuts against the spring seat 442, the movable contact piece 2 passes through the restrain frame 400 and abuts against the top wall 4431 under the elastic force of the over-travel spring 445, so that the over-travel spring 445 and the movable contact piece 2 are stably installed in the restrain frame 400 with the help of the elastic force of the over-travel spring 445.

Referring to FIGS. 43 and 44, the present embodiment adopts the spring seat 442 and the U-shaped bracket 443 forming the restrain frame 400. When the pyrotechnic actuator 5 is excited, the piston 52 impacts downward on the restrain frame 400, so that the push rod assembly 44 and the movable contact piece 2 move downward. After the spring seat 442 is stopped by the internal structure of the relay, the over-travel spring 445 is further compressed under the impact force of the piston 52. The two side walls 4432 of the U-shaped bracket 443 are compressed and bent, resulting in plastic deformation, so that the entire restrain frame 400 is flattened and cannot be restored, so that the height of the entire push rod assembly 44 and the movable contact piece 2 is further lowered. Since the U-shaped bracket 443 is straddled above the plate-shaped movable contact piece 2, it can restrain the movable contact piece 2 from rebounding toward the static contact 1. Moreover, due to downward impact of the piston 52, the restraint frame 400 is compressed and flattened, which can further widen the contact gap between the movable contact piece 2 and the static contact 1, thereby improving the short circuit safety. From another perspective, since the restraint frame 400 formed by the spring seat 442 and the U-shaped bracket 443 in this embodiment can be compressed and flattened, compared with other solutions in which the push rod assembly cannot be compressed and flattened, when the push rod assembly 44 and the movable contact piece 2 in this embodiment are impacted by the piston 52, only a smaller downward movement distance (adding the compressed space after the restraint frame 400 is flattened) is required to ensure that a sufficient contact gap is formed, so the height space of the contact chamber of the ceramic cover 6 can also be appropriately set to be smaller, which can be consistent with the specifications of the relay without the pyrotechnic actuator 5 (the existing relay with the pyrotechnic actuator 5 needs to increase the height space of the contact chamber), so that the height volume of the entire relay can also be reduced.

Referring to 41-46, the push rod assembly 44 further includes at least one group of magnetic conduction ring assembly, and each includes an upper magnet 447 and a lower magnet 446 together form a magnetic circuit around at least a portion of the current carrying conductor of the movable contact piece 2, so that when the movable contact piece 2 flows through a short circuit, the movable contact piece 2 is pushed upward by the magnetic attractive force of the upper magnet 447 on the lower magnet 446 to resist the electro-dynamic repulsion force caused by the short circuit. Specifically in the present embodiment, the upper magnet 447 has a linear structure, the lower magnet 446 has a U-shaped structure, the upper magnet 447 is fixedly connected to the lower side of the top wall 4431 and is thus arranged above the movable contact piece 2, the lower magnet 446 is fixedly connected to the movable contact piece 2 and semi-surrounds a portion of the current carrying conductor of the movable contact piece 2, and the opening of the lower magnet 446 in U-shaped faces the upper magnet 447, so that the upper magnet 447 and the lower magnet 446 form a magnetic circuit.

Since the upper magnet 447 is fixedly connected to the top wall 4431, and the lower magnet 446 is fixedly connected to the movable contact piece 2, when the relay is in the conducted state, that is, when the push rod assembly 44 pushes the movable contact piece 2 upward to contact the static contact 1, the lower magnet 446 cannot continue to rise due to the stopping of the static contact 1, but the spring seat 442 can further compress the over-travel spring 445, so that the restrain frame 400 can continue to rise, thereby creating a certain magnetic air gap between the upper magnet 447 and the lower magnet 446. At the same time, a further compression of the over-travel spring 445 also realizes the over-travel of the contact when the relay is in the conducted state.

In this embodiment, two groups of the magnetic conduction ring assemblies are provided, where a through hole 21 is provided in the middle of the movable contact piece 2 in the width direction, and two current carrying conductors are separated in the width direction of the movable contact piece 2 through the through hole 21. The two groups of the magnetic conduction ring assemblies are respectively surrounded on the two current carrying conductors to form independent magnetic circuits.

In this embodiment, the restraint frame 400 is adopted to fix the upper magnet 447, other fixing structures may also be used in other embodiments, such as a rod passing through the movable contact piece 2, and the upper magnet is fixed to one end of the rod passing through the movable contact piece 2.

The “magnetic conduction ring assembly” proposed in this embodiment refers to the upper magnet and the lower magnet being able to form a ring-shaped magnetic circuit. Specifically, one of the upper magnet and the lower magnet is a linear structure and the other is a U-shaped structure. In other embodiments, the upper magnet and the lower magnet may both be linear structures. This structure can also form a ring-shaped magnetic circuit (for example, a similar structure in Chinese patent CN103038851B), which also belongs to the category of “the magnetic conduction ring assembly” referred to in this embodiment.

As shown in FIG. 46, two magnetic circuits are provided in this embodiment, which can increase the magnetic pole faces (there are four magnetic pole faces in total), improve the magnetic efficiency, and increase the attraction force. When the movable contact piece 2 has a large fault current, the two independent magnetic circuits, namely the magnetic circuit φ1 and the magnetic circuit φ2, generate attraction force F to resist the electro-dynamic repulsion force generated by the fault current between the movable contact piece and the static contact, thereby greatly improving the anti-short circuit ability. Moreover, by separating the movable contact piece 2 into two current carrying conductors, the current can be shunted. The shunted current on one current carrying conductor is basically half of the fault current. The magnetic circuit will not be magnetically saturated, the magnetic flux will increase, and the attraction force generated will also increase.

More information about the structure and function of the magnetic conduction ring assembly (the upper magnet 447 and the lower magnet 446) are described in Chinese patent CN209000835U.

In this embodiment, the magnetic conduction ring assembly is provided. First, the anti-short circuit ability of the relay can be improved, so that the relay can be applied in the occasions with high anti-short circuit requirements. Second, the over-travel spring with a small elastic coefficient k value can be selected or the compression amount of the over-travel spring can be reduced, so as to improve the reliability of the pyrotechnic actuator 5. Third, the disconnection of the contacts can be accelerated, so as to improve the electrical safety.

As described above, when a large fault current occurs in the movable contact piece 2, the magnetic conduction ring assembly can generate an upward magnetic attractive force on the movable contact piece 2 to help resist the electro-dynamic repulsion force generated by the large current in the load circuit between the movable contact piece 2 and the static contact 1 (the magnetic attractive force can increase synchronously with the increase of the electro-dynamic repulsion force), thereby greatly improving the anti-short circuit ability, so that the upper limit of the set value of the excitation current of the pyrotechnic actuator can be increased; and, for the conventional relay without the magnetic conduction ring assembly, the electro-dynamic repulsion force is resisted by the elastic force of the over-travel spring on the movable contact piece 2. Since the electro-dynamic repulsion force at the moment of short circuit is very large (the short circuit has not reached the threshold value for exciting the pyrotechnic actuator), the compression amount or elastic coefficient of the over-travel spring needs to be set larger to have sufficient elastic force to resist the electro-dynamic repulsion force, and the compression amount or elastic coefficient of the over-travel spring coefficient needs to be set larger, which means that if the over-travel spring is to be further compressed, a larger external force is required. Therefore, when the pyrotechnic actuator 5 is excited, a larger impact force is required to further compress the over-travel spring, thereby pushing the movable contact piece 2 down. However, the present embodiment is provided with the magnetic conduction ring assembly. When the load circuit current (or fault current) is large, the magnetic attractive force of the magnetic conduction ring assembly is mainly relied on to resist the electro-dynamic repulsion force. The elastic force of the over-travel spring is smaller than the maximum electro-dynamic repulsion force between the static contact 1 and the movable contact piece 2. Therefore, the elastic force of the over-travel spring (the contact pressure on the movable contact piece) can be set smaller, that is, the over-travel spring with a small elastic coefficient k value can be used, or the compression amount of the over-travel spring can be made smaller, so that the over-travel spring is more easily compressed, so that the impact force generated by the pyrotechnic actuator 5 does not need to be large, so the amount of gunpowder of the pyrotechnic actuator 5 can also be reduced, thereby improving the safety performance. In addition, due to the contact pressure of the over-travel spring on the movable contact piece. Therefore, the contact holding force of the movable iron core 43 in the electromagnetic drive mechanism 4 can be reduced accordingly. For example, in actual design, the diameter of the movable iron core 43, the elastic force of the reset spring 45, the attraction force of the coil 42, etc. can be reduced, thereby further reducing the amount of gunpowder required for the pyrotechnic actuator and improving the reliability of the pyrotechnic actuator; Moreover, since the piston 52 impacts downward and flattens the restrain frame 400, restraining the movable contact piece 2 from rebounding toward the static contact 1, the over-travel spring is more easily compressed, the piston 52 has greater energy to impact the restrain frame 400, ensuring that the restrain frame 400 cannot recover the deformation; In addition, once the short circuit exceeds and triggers the monitoring current value set by the monitoring excitation circuit, the attraction force of the lower magnet 446 on the upper magnet 447 increases, and since the magnetic attractive force of the lower magnet 446 on the upper magnet 447 is superimposed on the electro-dynamic repulsion force, which makes the magnetic attractive force of the static iron core 41 on the movable iron core 43 insufficient to support the movable iron core 43 and the push rod assembly 44, the movable iron core 43 will fall off first, driving the push rod assembly 44 and the movable contact piece 2 to fall. At the same time, the pyrotechnic actuator 5 is excited, and the piston 52 impacts downward on the U-shaped bracket 443 until the upper magnet 447 contacts the movable contact piece 2. The upper magnet 447, the movable contact piece 2 and the lower magnet 446 form a whole, the mutual magnetic attractive force between the upper magnet 447 and the lower magnet 446 becomes an internal force, until the movable contact piece 2 finally breaks away from the static contact 1, the magnetic attractive force of the magnetic conduction ring assembly used to resist the electro-dynamic repulsion force disappears. During this process, the pushing force of the piston 52 is superimposed on the electro-dynamic repulsion force. The downward force of the force pushes the movable contact piece 2 to further accelerate its downward movement, accelerates the disconnection of the contacts, shortens the disconnection time, and further improves the electrical safety of the product.

This embodiment uses a relay structure to illustrate the functions and effects of the pyrotechnic actuator 5, the magnetic conduction ring assembly and the push rod assembly 44. In addition to the relay, the same structure can also be applied to other switch apparatuses, such as a contactor.

### The Eleventh Embodiment

Referring to FIG. 47, this embodiment proposes a relay, whose structure is similar to the relay of the tenth embodiment, except that in this embodiment, only one group of the magnetic conduction ring assembly is provided on the movable contact piece 2A, and the magnetic conduction ring assembly includes an upper magnet 447A and a lower magnet 446A. This embodiment is applicable to the relays with lower anti-short circuit ability than that in the tenth embodiment. Only one set of the magnetic conduction ring assembly is used, which can simplify the number of parts and the structure, and facilitate production and assembly.

### The Twelfth Embodiment

Referring to FIG. 48, this embodiment proposes a relay, whose structure is similar to the relay of the tenth embodiment, except that in this embodiment, three groups of the magnetic conduction ring assemblies are provided on the movable contact piece 2B, and each group of the magnetic conduction ring assemblies includes an upper magnet 447B and a lower magnet 446B. The present embodiment is applicable to the relay with higher anti-short circuit ability than that of the tenth embodiment, and can improve the anti-short circuit ability of the relay by improving the magnetic attractive force of the magnetic conduction ring assembly.

In addition, since the pyrotechnic actuator is provided to impact the movable contact for quick disconnection, a larger space needs to be reserved to match the stroke of the piston in the pyrotechnic actuator. Moreover, since the pyrotechnic actuator needs to be installed, the relay with the pyrotechnic actuator has a larger volume, which is not conducive to miniaturization of the product.

Therefore, the present disclosure also proposes a switch apparatus having a pyrotechnic actuator with an optimized structure.

The present disclosure adopts following technical solutions:

The present disclosure proposes a switch apparatus having a pyrotechnic actuator, including a switch body and a pyrotechnic actuator arranged on the body. The switch body includes a direct-acting electromagnetic drive mechanism, and a fixedly arranged static contact part and a movable contact part to perform a switch function, the direct-acting electromagnetic drive mechanism is used to drive the movable contact part to approach or move away from the static contact part to achieve circuit connection or disconnection, the pyrotechnic actuator includes a pushing medium for performing downward movement, the pushing medium forces the movable contact part to move away from the static contact part after downward movement, the switch apparatus also includes a restraint part, the restraint part is arranged at a position corresponding to the downward movement of the piston, the restraint part is coupled and assembled with the movable contact part, and the restraint part is configured to be able to restrain the movable contact part from returning toward the static contact part. The material of the restraint part is materials that do not recover deformation after being impacted by the pushing medium.

The pushing medium is the high-pressure gas generated by the ignition of the pyrotechnic actuator, or the pushing medium is the piston.

In one embodiment, the restraint part is a restraint frame, and the restraint frame is flattened and cannot recover its deformation after receiving the impact of the pushing medium, thereby restraining the movable contact part from returning toward the static contact part.

In an embodiment, the restraint part is made of stainless steel or low carbon steel.

In one embodiment, based on manufacturing and installation considerations, the movable contact part is a plate-shaped structure, and the restrain frame is straddled on the plate-shaped movable contact part to restrain it from returning to the static contact part.

In one embodiment, the electromagnetic drive mechanism includes a push rod, the restraint frame fixedly connected to an end of the push rod, the movable contact part passing through the restraint frame. An over-travel elastic piece is fixedly installed inside the restrain frame. Through the elastic force of the over-travel elastic piece, the movable contact part pushes the movable contact part toward the upper end of the restraint frame. After the restraint frame moves upward to make the movable contact part and the static contact part abut against each other, the electromagnetic drive mechanism drives the push rod and the restraint frame to continue to move upward to compress the over-travel elastic piece, thereby achieving over-travel of the movable contact part.

Based on manufacturing and installation considerations, in an embodiment, the restraint frame includes a U-shaped bracket at the top and a linear base frame at the bottom, the U-shaped bracket includes a top wall and two the side walls extending downward from both ends of the top wall, the two the side walls are fixedly connected to both ends of the base frame to form the restraint frame in a square frame shape, after the restraint frame receives the impact of the pushing medium, the side walls are bent, so that the restraint frame is flattened and cannot be restored. Alternatively, in another embodiment, the restraint frame includes a U-shaped base frame at the bottom and a linear top wall at the top, the base frame includes a base and two the side walls extending upward from both ends of the base, the two the side walls are fixedly connected to both ends of the top wall to form the restraint frame in a square frame shape, after the restraint frame receives the impact of the pushing medium, the side walls are bent, so that the restraint frame is flattened and cannot be restored.

In order to make the side wall easier to bend, in one embodiment, the side wall is a hollow and/or thin sheet structure.

In order to make the side wall easier to bend, in one embodiment, the side wall is a wave-shaped bending structure.

The switch apparatus is a direct current high voltage relay.

The present disclosure has following beneficial effects: the present disclosure, a restraining piece which does not recover deformation after receiving the impact of the piston is arranged, which can restrain the movable contact part from rebounding toward the static contact part after the pyrotechnic actuator is excited, and the height of the entire push rod assembly and the movable contact part is further depressed, further widening the contact gap between the movable contact part and the static contact part, thereby improving short circuit safety. The present disclosure only requires a smaller downward movement distance to ensure that the contact gap is widened sufficiently large, so that the height space of the contact chamber of the switch apparatus can be appropriately reduced, thereby reducing the height and volume of the entire switch apparatus.

The present disclosure is now further described in conjunction with the accompanying drawings and specific implementation methods.

### The Thirteenth Embodiment

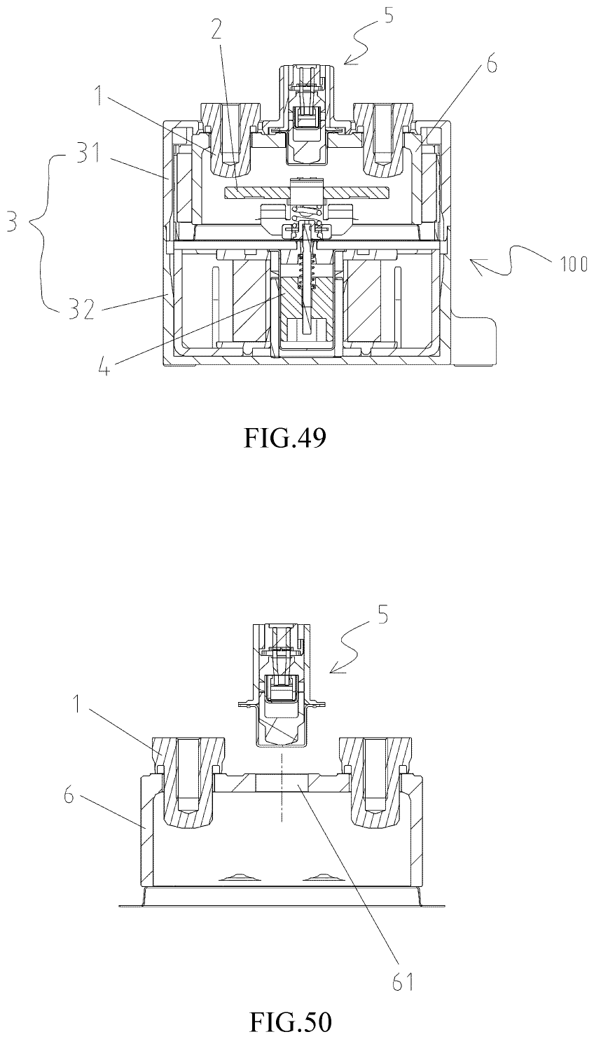

FIGS. 49-50, as an embodiment of the present disclosure, a relay having a pyrotechnic actuator is provided, which includes a relay body 100 and a pyrotechnic actuator 5 mounted and attached to the relay body 100. The relay body 100 includes a static contact 1 (as the static contact part) and a movable contact piece 2 (as the movable contact part) for realizing the connection or disconnection thereof. The relay body 100 also includes an outer housing 3, one end of the static contact 1 is exposed outside of the outer housing 3 and electrically connected to the external load, and the other end is inserted into the inner part of the outer housing 3, and the movable contact piece 2 is arranged inside the outer housing 3 and connected to an electromagnetic drive mechanism 4. The static contact 1 is provided with an internal thread, which can be used to be threadedly connected and fixed with the external terminal. The movable contact piece 2 is a bridge-type movable contact piece, under the action of the electromagnetic drive mechanism 4, the movable contact piece 2 can move relatively close to or away from the static contact 1. When the movable contact piece 2 contacts two static contacts 1 at the same time, the load is connected. For the convenience of description, it is described that the static contact 1 is relatively above the movable contact piece 2, and the movable contact piece 2 is relatively below the static contact 1.

The relay body 100 further includes a ceramic cover 6, which is fixedly arranged inside the outer housing 3 and covers the lower end of the static contact 1 and the movable contact piece 2 (i.e., covers the static contact 1, the movable contact piece 2, and the contact therebetween) to form a contact chamber. The ceramic cover 6 isolates the contacts between the static contact 1 and the movable contact piece 2 from the outside air to obtain high voltage resistance performance, which can effectively ensure that the relay has low contact resistance, long life, and high reliability. When the relay is short-circuited, the arc resistance and high temperature resistance of the ceramic material can ensure, so that the circuit under the short-circuit arc is safe and reliable.

The outer housing 3 further includes a base 32 and a cover 31 which are connected to each other, the ceramic cover 6 is arranged inside the cover 31, the pyrotechnic actuator 5 is inserted from the outside of the ceramic cover 6 and fixedly connected to the ceramic cover 6, the lower end of the pyrotechnic actuator 5 extends into the contact chamber of the ceramic cover 6 to face the movable contact piece 2, and the cover 31 is then covered on the ceramic cover 6 and the pyrotechnic actuator 5 to complete the overall assembly of the relay. Referring to FIG. 50, the pyrotechnic actuator 5 is an independent modular construction, and its appearance is generally a columnar rotating body structure, a mounting hole 61 is opened at the upper end of the ceramic cover 6, and the lower end of the pyrotechnic actuator 5 passes through the mounting hole 61 to extend into the contact chamber. The pyrotechnic actuator 5 can be fixed on the ceramic cover 6 by welding, riveting, screwing, etc. In this embodiment, the pyrotechnic actuator 5 is fixed on the ceramic cover 6 by brazing. In addition, in this embodiment, the top surface of the cover 31 has through holes and a hollow cylindrical section for amounting and matching two static contacts 1 and one pyrotechnic actuator 5, so that the top ends of the two static contacts 1 can be exposed to the outer housing 3, and the outside of the pyrotechnic actuator 5 can be covered and protected. In addition, in order to improve electrical safety, a protective baffle (not shown in the Figure due to angle problem) is extended from both sides of the outer wall of the hollow cylindrical section in a direction perpendicular to the paper surface. In other embodiments, the pyrotechnic actuator 5 may also be fixedly connected to the outer housing 3, but in this embodiment, the pyrotechnic actuator 5 is fixedly connected to the ceramic cover 6 to simplify the assembly process. During final assembly, the pyrotechnic actuator 5 and the static contact 1 are fixedly assembled on the ceramic cover 6 and then the cover 31 is covered.

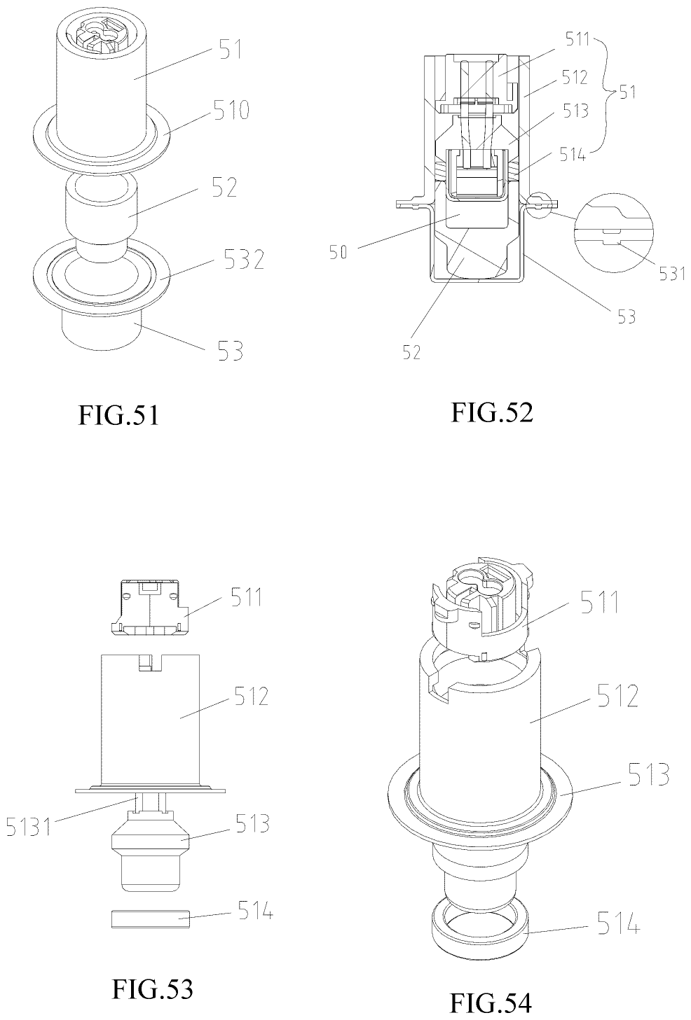

Referring to FIGS. 51-54, the pyrotechnic actuator 5 specifically includes an actuator 51, a piston 52 (as the pushing medium) and a bottom shell 53. The actuator 51 and the bottom shell 53 are fixedly connected one above and one below, and the piston 52 is accommodated between the actuator 51 and the bottom shell 53. The actuator 51 further includes a hollow actuator base 512, and a connector 511, an igniter 513 and a sealing ring 514 installed inside the actuator base 512. The actuator base 512 and the bottom shell 53 are fixedly connected to form the outer housing of the pyrotechnic actuator 5. The connector 511, the igniter 513, the sealing ring 514 and the piston 52 are sequentially arranged inside the outer housing from top to bottom, and the connector 511 is connected to the lead 5131 of the igniter 513. The connector 511 is fixedly connected to the outer housing by clamping. The sealing ring 514 is pressed into the inner wall of the actuator base 512 by interference fit, and the actuator base 512 presses the igniter 513 upwards and fixes it. The upper and lower ends of the piston 52 are respectively pressed by the sealing ring 514 and the bottom shell 53. The sealing ring 514 can play roles of moisture-proof and air-tight. The micro-deformation of the sealing ring 514 under pressure can further press the igniter 513 above and the piston 52 below to prevent vibration loosening.

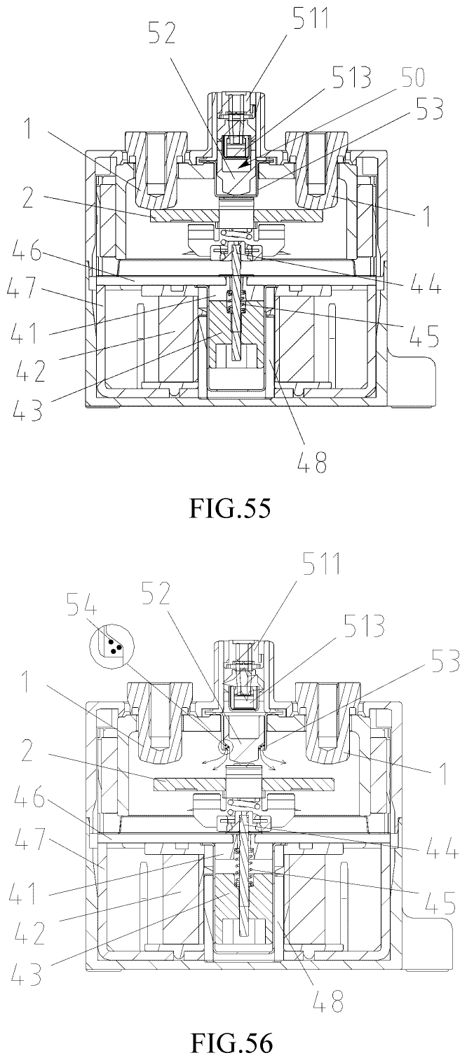

Referring to FIGS. 55-56, the connector 511 is used to fix the ignition lead of the monitoring excitation circuit to transmit the excitation electrical signal emitted by the monitoring excitation circuit to excite the igniter 513. The monitoring excitation circuit may emit an excitation electrical signal to be transmitted downward through the connector 511 after the monitoring current value (or current climbing rate) reaches a certain threshold value, and excite the igniter 513 to ignite. An air gap 50 is provided between the piston 52 and the igniter 513. After the igniter 513 ignites the gunpowder, high-pressure gas is generated in the air gap 50) (i.e., ignition is performed), pushing the piston 52 downward to break through the bottom shell 53, and then the piston 52 pushes the movable contact piece 2 downward to help the movable contact piece 2 disconnect with the contact with the static contact 1, so as to achieve the rapid disconnection of the relay.

The bottom shell 53 of the pyrotechnic actuator 5 is a hollow cylindrical structure, and the piston 52 is a rotating body structure arranged inside the bottom shell 53 through the shaft hole, so that the bottom shell 53 can guide the piston 52, so that the piston 52 moves axially downward along the hollow cylindrical inner chamber of the bottom shell 53 after the igniter 513 is ignited.

In this embodiment, the piston 52 is used to execute the downward movement of the pyrotechnic actuator. In other embodiments, the pyrotechnic actuator may not be provided with the piston, and simply relies on the igniter 513 to ignite the gunpowder to generate high-pressure gas to break through the bottom shell 53 and push the movable contact piece 2. In other words, the pushing medium used to realize the downward pushing of the movable contact piece 2 by the pyrotechnic actuator can be either the high-pressure gas itself or the piston 52.

Referring to FIG. 55-56, the electromagnetic drive mechanism 4 is used to drive the movable contact piece 2 to move. As shown in FIG. 55, the electromagnetic drive mechanism 4 specifically includes a static iron core 41, a coil 42, a movable iron core 43, a push rod assembly 44 and a reset spring 45, as well as a first yoke 46, a second yoke 47 and a magnetic cylinder 48 for transmitting magnetic lines of flux and improving the utilization rate of magnetic energy. The lower end of the push rod assembly 44 is fixedly connected to the movable iron core 43, and the upper end is linked to the movable contact piece 2. One end of the reset spring 45 acts on the static iron core 41, and the other end acts on the movable iron core 43. When the coil 42 is powered on the static iron core 41 attracts the movable iron core 43 to move upward, so that the push rod 44 pushes the movable contact piece 2 upward; When the coil 42 is powered off, the electromagnetic drive mechanism 4 is reset under the elastic force of the reset spring 45. The electromagnetic drive mechanism 4 is a common direct-moving magnetic circuit structure, and its operating principle is not described in detail in this embodiment.

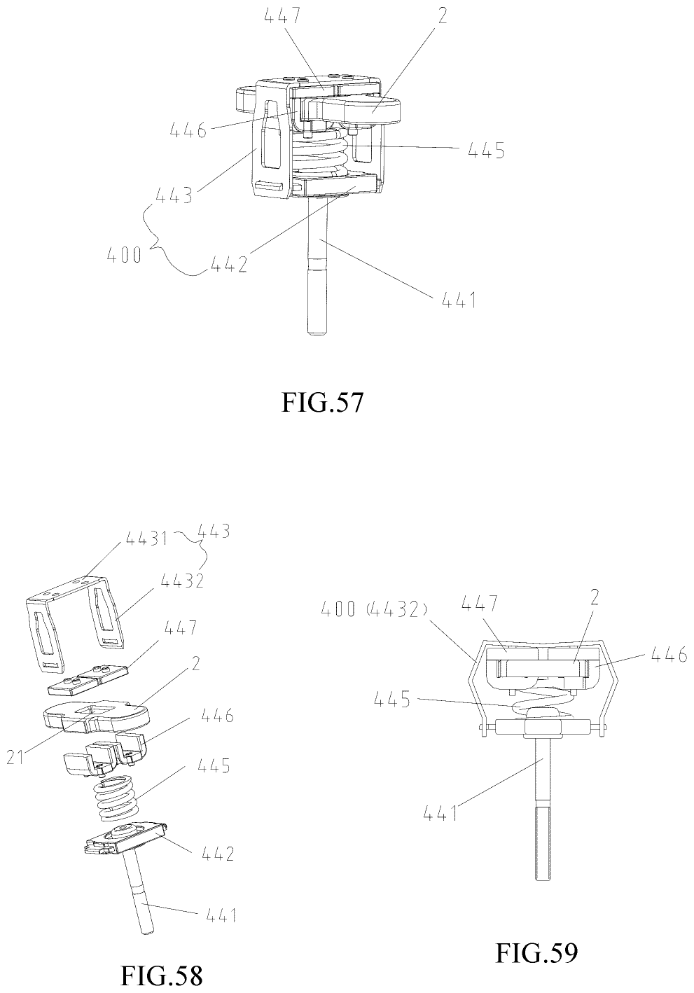

Referring to FIGS. 57-58, the push rod assembly 44 includes a push rod 441, a spring seat 442 (as a bottom frame) and a U-shaped bracket 443. The push rod 441 is used to output the driving force of the electromagnetic drive mechanism 4, its lower end is fixedly connected to the movable iron core 43 (refer to FIG. 56), and its upper end is fixedly connected to the spring seat 442. The U-shaped bracket 443 is a sheet structure, including a top wall 4431 horizontally placed above the spring seat 442 and two side walls 4432 connected to both ends of the top wall 4431 and extending downward. The lower ends of the two side walls 4432 are fixedly connected to both ends of the spring seat 442, so that the spring seat 442 and the U-shaped bracket 443 are connected to form a square hollow restraint frame 400. The lower end of the over-travel spring 445 abuts against the spring seat 442, and the movable contact piece 2 passes through the restrain frame 400 and abuts against the top wall 4431 under the elastic force of the over-travel spring 445, so that the over-travel spring 445 and the movable contact piece 2 are stably installed in the restrain frame 400 by the elastic force of the over-travel spring 445. In addition, when the push rod assembly 44 pushes the movable contact piece 2 upward to contact with the static contact 1, the spring seat 442 can further compress the over-travel spring 445, thereby achieving the over-travel of the contact when the relay is in the conducted state.

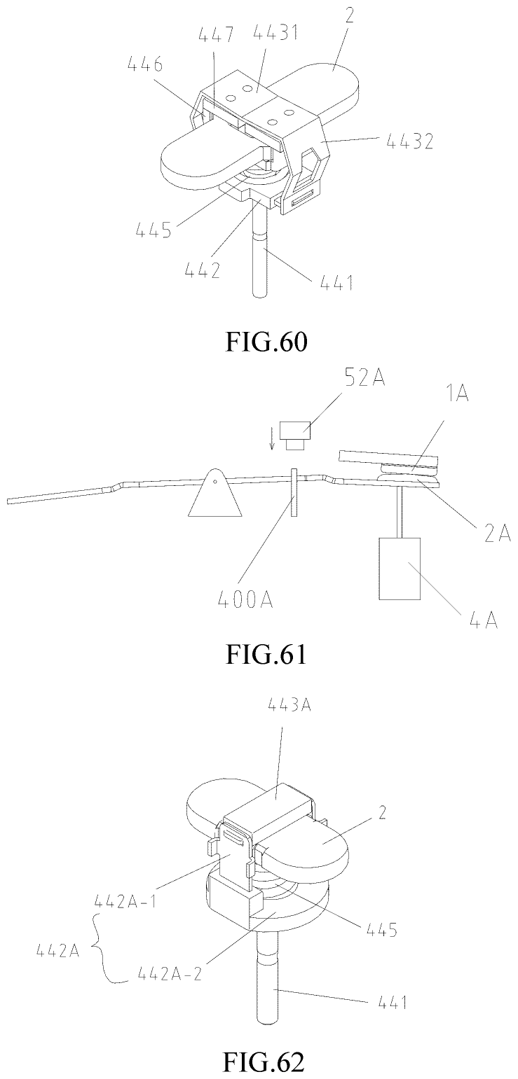

Referring to FIGS. 56 and 59-60, the present embodiment adopts the spring seat 442 and the U-shaped bracket 443 forming the restrain frame 400. When the pyrotechnic actuator 5 is excited, the piston 52 impacts downward on the restrain frame 400, so that the push rod assembly 44 and the movable contact piece 2 move downward. After the spring seat 442 is stopped by the internal structure of the relay, the over-travel spring 445 is further compressed under the impact force of the piston 52. The two side walls 4432 of the U-shaped bracket 443 are compressed and bent, resulting in plastic deformation, so that the entire restrain frame 400) is flattened and cannot be restored, so that the height of the entire push rod assembly 44 and the movable contact piece 2 is further lowered. Since the U-shaped bracket 443 is straddled above the plate-shaped movable contact piece 2, it can restrain the movable contact piece 2 from rebounding toward the static contact 1. Moreover, due to downward impact of the piston 52, the restraint frame 400 is compressed and flattened, which can further widen the contact gap between the movable contact piece 2 and the static contact 1, thereby improving the short circuit safety. From another perspective, since the restraint frame 400 formed by the spring seat 442 and the U-shaped bracket 443 in this embodiment can be compressed and flattened, compared with other solutions in which the push rod assembly cannot be compressed and flattened, when the push rod assembly 44 and the movable contact piece 2 in this embodiment are impacted by the piston 52, only a smaller downward movement distance (adding the compressed space after the restraint frame 400 is flattened) is required to ensure that a sufficient contact gap is formed, so the height space of the contact chamber of the ceramic cover 6 can also be appropriately set to be smaller, which can be consistent with the specifications of the relay without the pyrotechnic actuator 5 (the existing relay with the pyrotechnic actuator 5 needs to increase the height space of the contact chamber), so that the height volume of the entire relay can also be reduced.

In some embodiments, the U-shaped bracket 443 is made of materials that do not recover deformation, such as stainless steel or low carbon steel. In addition, in this embodiment, the side wall 4432 is a hollow sheet structure, so that the side wall 4432 is more easily bent under pressure.

In this embodiment, the restraint frame 400 is adopted to install the movable contact piece 2 and realize the rebound recovery of the movable contact piece 2 toward the static contact 1. Other restraint parts can also be used to replace the restraint frame 400 in other embodiments. For example, the movable contact piece 2 is fixedly connected to the end of a support rod, but the support rod body is designed to be a structure that can accept impact and produce axial compression and does not recover deformation. As long as the restraint part is configured to be able to restrain the movable contact piece 2 to return toward the static contact 1 and is coupled and assembled with the movable contact piece 2, it is feasible.

This embodiment uses a relay structure to illustrate the functions and effects of the pyrotechnic actuator 5 and the push rod assembly 44. In addition to the relay, the same structure can also be applied to other switch apparatuses, such as contactors.

### The Fourteenth Embodiment

Referring to FIG. 61, the present embodiment provides a relay including a static contact part 1A and a movable contact part 2A, where the movable contact part 2A is a seesaw structure, and the movable contact part 2A is driven by the electromagnetic drive mechanism 4A to contact or separate from the static contact part 1A. The relay also includes a pyrotechnic actuator, and the pyrotechnic actuator includes a piston 52A, and the piston 52A can force the movable contact part 2A to move away from the static contact part 1A after moving downward. A restrain frame 400A is provided at a position corresponding to the lower part of the piston 52A, and the restrain frame 400A is straddled on the seesaw movable contact part 2A. After receiving the impact of the piston 52A, the restrain frame 400A is flattened and cannot recover its deformation, thereby restraining the movable contact part 2A from returning to the static contact part 1A.

That is, the restrain part (the restrain frame 400A) can be applied not only to the direct-acting contact circuit of the thirteenth embodiment, but also to the contact circuit of the seesaw of this embodiment. Any contact circuit structure that utilizes the non-recoverable deformation property of the restrain part to restrain the movable contact part is feasible.

### The Fifteenth Embodiment

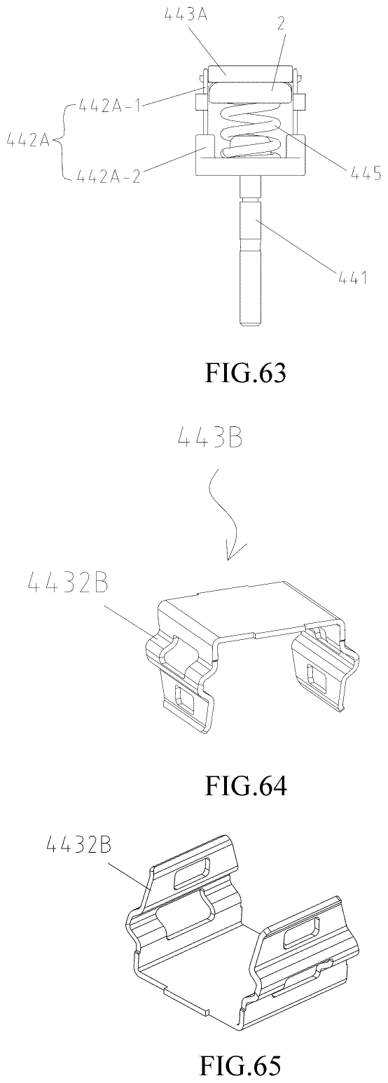

This embodiment proposes a relay, which has a structure similar to the relay of the thirteenth embodiment, except that the restraint frame structure of the push rod assembly. Referring to FIGS. 62-63, in this embodiment, the restraint frame includes a U-shaped spring seat 442A (as a base frame) and a top wall 443A, the spring seat 442A includes a base 442A-2 and side walls 442A-1 extending upward from both ends of the base 442A-2, the side wall 442A-1 is fixedly connected to the top wall 443A so that the spring seat 442A and the top wall 443A are connected to form the restraint frame. When impacted by the piston, the side wall 442A-1 bends so that the entire restraint frame is flattened.

This embodiment differs from the thirteenth embodiment is that in the thirteenth embodiment, the structure of the restraint frame 400 is realized by an inverted U-shaped bracket 443 and a linear spring seat 442 connected below it, while in this embodiment, the structure of the restraint frame 400) is realized by a U-shaped spring seat 442A and a top wall 443 connected above it. Although the structure of this embodiment is different from that of the thirteenth embodiment, it has the same technical effect.

In this embodiment and the thirteenth embodiment, the side wall is either integrally connected to the spring seat (i.e., the U-shaped structure of the spring seat 442A) or integrally connected to the top wall (i.e., the U-shaped bracket 443). In other embodiments, the side wall may also be configured as a separate structure, and during assembly, the two ends of the side wall are respectively fixedly connected to the top wall and the spring seat to obtain the restraint frame.

### The Sixteenth Embodiment

This embodiment proposes a relay, whose structure is similar to the relay of the thirteenth embodiment, except for the structure of the U-shaped bracket. Referring to FIGS. 64-65, in this embodiment, the side wall 4432B of the U-shaped bracket 443B is wavy, rather than the straight sheet in the thirteenth embodiment. The wavy structure of the side wall 4432B in this embodiment can make the side wall 4432B easier to bend under pressure, so that the explosive force of the pyrotechnic actuator can be adaptively reduced.

In addition, the existing relay with the pyrotechnic actuator usually does not have an arc-extinguishing system because additional space is required to set up the pyrotechnic actuator, resulting in poor arc extinguishing ability of the relay and insufficient anti-reignition performance.

Therefore, the present disclosure also proposes a switch apparatus having a pyrotechnic actuator with an optimized structure.

The present disclosure adopts following technical solutions:

The present disclosure provides a switch apparatus having a pyrotechnic actuator, including a switch body and a pyrotechnic actuator arranged on the body, the switch body includes a static contact part and a movable contact part arranged to perform a switch function, the pyrotechnic actuator generates an explosive impact force by igniting gunpowder, forcing the movable contact part to move away from the static contact part so that the switch apparatus is quickly disconnected, the pyrotechnic actuator includes an actuator, a piston and a bottom shell, the actuator ignites gunpowder and pushes the piston to break through the bottom shell through the gas, and the piston then impacts the movable contact part to make it away from the static contact part, the switch apparatus also includes an arc-extinguishing medium, the arc-extinguishing medium is arranged in the bottom shell or the piston, after the bottom shell or the piston is broken, the arc-extinguishing medium is released into the space between the contacts of the movable contact part and the static contact part, so as to extinguish the arc generated between the contacts of the movable contact part and the static contact part.

Based on manufacturing and installation considerations, in an embodiment, the switch body includes an outer housing and a ceramic cover arranged inside the outer housing, the ceramic cover covers the static contact part, the movable contact part and the contact parts thereof to form a contact chamber, the contacts of the movable contact part and the static contact part are arranged in the contact chamber, and the arc-extinguishing medium is spread in the contact chamber by the explosive impact force generated by the pyrotechnic actuator to extinguish the arc generated between the contacts of the movable contact part and the static contact part.

In one embodiment, the piston is provided with a groove which is open toward the actuator, and the arc-extinguishing medium is solid and stored in the groove.

In one embodiment, the arc-extinguishing medium is stored in the piston, and at least the impact portion of the piston is made of a brittle material.

In an embodiment, the arc-extinguishing medium is quartz sand.

one embodiment, the piston has a sealed chamber, and the arc-extinguishing medium is gaseous or liquid and is sealed in the sealed chamber.

In an embodiment, the arc-extinguishing medium is sulfur hexafluoride gas or transformer oil.

In one embodiment, the piston or the bottom shell is a structure that gradually contracts toward the movable contact part.

In an embodiment, the switch body includes an outer housing, the movable contact part is arranged inside the outer housing, and the pyrotechnic actuator extends into the outer housing to face the movable contact part.

In one embodiment, the movable contact part is a bridge-type movable contact piece. The static contact part includes two static contacts set at both ends of the bridge-type movable contact piece, the pyrotechnic actuator is set on one side of the middle section of the bridge-type movable contact piece. After the piston breaks through the bottom shell, the gas generated by the ignition and explosion of the pyrotechnic actuator is guided to two ends of the bridge-type movable contact piece under the guidance of the piston and the bottom shell, and quickly reached the space between the contacts of the bridge-type movable contact piece and the static contact.

The switch apparatus is a direct current high voltage relay.

The present disclosure has following beneficial effects: in present disclosure, uses the piston of the pyrotechnic actuator break through the bottom shell downwards to release the arc-extinguishing medium into the contact chamber of the switch apparatus for arc extinguishing treatment, thus further accelerating the arc extinguishing ability when the contacts are disconnected, and improving the short-circuit safety of the product.

The present disclosure is now further described in conjunction with the accompanying drawings and specific implementation methods.

### The Seventeenth Embodiment

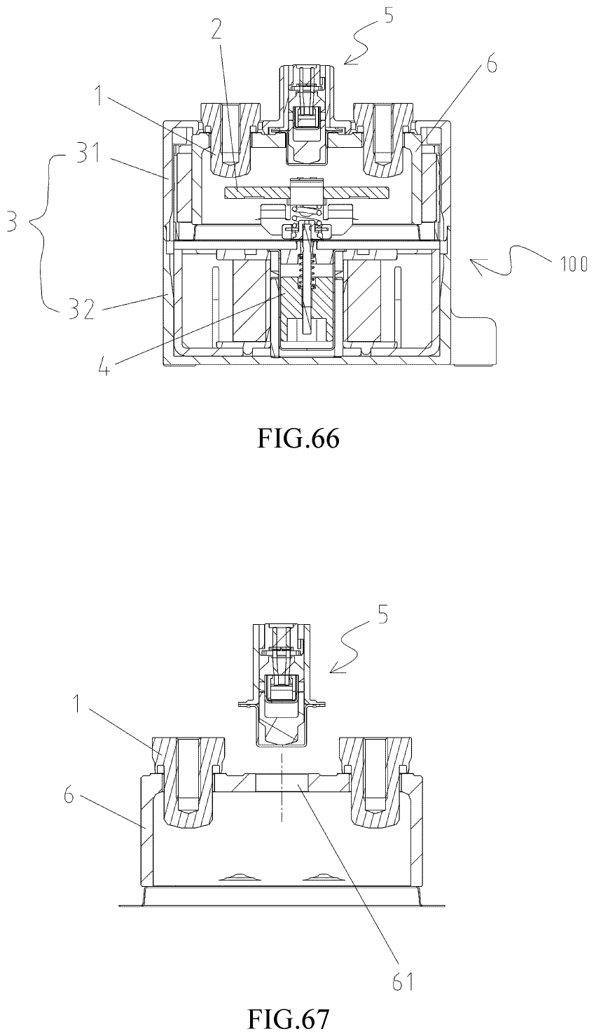

Referring to FIGS. 66-67, as an embodiment of the present disclosure, a relay having a pyrotechnic actuator is provided, which includes a relay body 100 and a pyrotechnic actuator 5 mounted and attached to the relay body 100. The relay body 100 includes a static contact 1 (as the static contact part) and a movable contact piece 2 (as the movable contact part) for realizing the connection or disconnection thereof. The relay body 100 also includes an outer housing 3, one end of the static contact 1 is exposed outside of the outer housing 3 and electrically connected to the external load, and the other end is inserted into the inner part of the outer housing 3, and the movable contact piece 2 is arranged inside the outer housing 3 and connected to an electromagnetic drive mechanism 4. The static contact 1 is provided with an internal thread, which can be used to be threadedly connected and fixed with the external terminal. The movable contact piece 2 is a bridge-type movable contact piece, under the action of the electromagnetic drive mechanism 4, the movable contact piece 2 can move relatively close to or away from the static contact 1. When the movable contact piece 2 contacts two static contacts 1 at the same time, the load is connected. For the convenience of description, it is described that the static contact 1 is relatively above the movable contact piece 2, and the movable contact piece 2 is relatively below the static contact 1.

The relay body 100 further includes a ceramic cover 6, which is fixedly arranged inside the outer housing 3 and covers the lower end of the static contact 1 and the movable contact piece 2 (i.e., covers the static contact 1, the movable contact piece 2 and the contact therebetween) to form a contact chamber. The ceramic cover 6 isolates the contacts between the static contact 1 and the movable contact piece 2 from the outside air to obtain high voltage resistance performance, which can effectively ensure the low contact resistance, long life and high reliability of the relay. When the relay is short-circuited, the arc resistance and high temperature resistance of the ceramic material can ensure the safety and reliability of the circuit under the short-circuit arc.

The outer housing 3 further includes a base 32 and a cover 31 which are connected to each other, the ceramic cover 6 is arranged inside the cover 31, the pyrotechnic actuator 5 is inserted from the outside of the ceramic cover 6 and fixedly connected to the ceramic cover 6, the lower end of the pyrotechnic actuator 5 extends into the contact chamber of the ceramic cover 6 to face the movable contact piece 2, and the cover 31 is then covered on the ceramic cover 6 and the pyrotechnic actuator 5 to complete the overall assembly of the relay. Referring to FIG. 67, the pyrotechnic actuator 5 is an independent modular construction, and its appearance is generally a columnar rotating body structure, a mounting hole 61 is opened at the upper end of the ceramic cover 6, and the lower end of the pyrotechnic actuator 5 passes through the mounting hole 61 to extend into the contact chamber. The pyrotechnic actuator 5 can be fixed on the ceramic cover 6 by welding, riveting, screwing, etc. In this embodiment, the pyrotechnic actuator 5 is fixed on the ceramic cover 6 by brazing. In addition, in this embodiment, the top surface of the cover 31 has through holes and a hollow cylindrical section for mounting and matching two static contacts 1 and the pyrotechnic actuator 5, so that the top ends of the two static contacts 1 can be exposed to the outer housing 3, and the outside of the pyrotechnic actuator 5 can be covered and protected. In addition, in order to improve electrical safety, a protective baffle is extended from both sides of the outer wall of the hollow cylindrical section in a direction perpendicular to the paper surface. In other embodiments, the pyrotechnic actuator 5 may also be fixedly connected to the outer housing 3, but in this embodiment, the pyrotechnic actuator 5 is fixedly connected to the ceramic cover 6 to simplify the assembly process. During final assembly, the pyrotechnic actuator 5 and the static contact 1 are fixedly assembled on the ceramic cover 6 and then the cover 31 is covered.

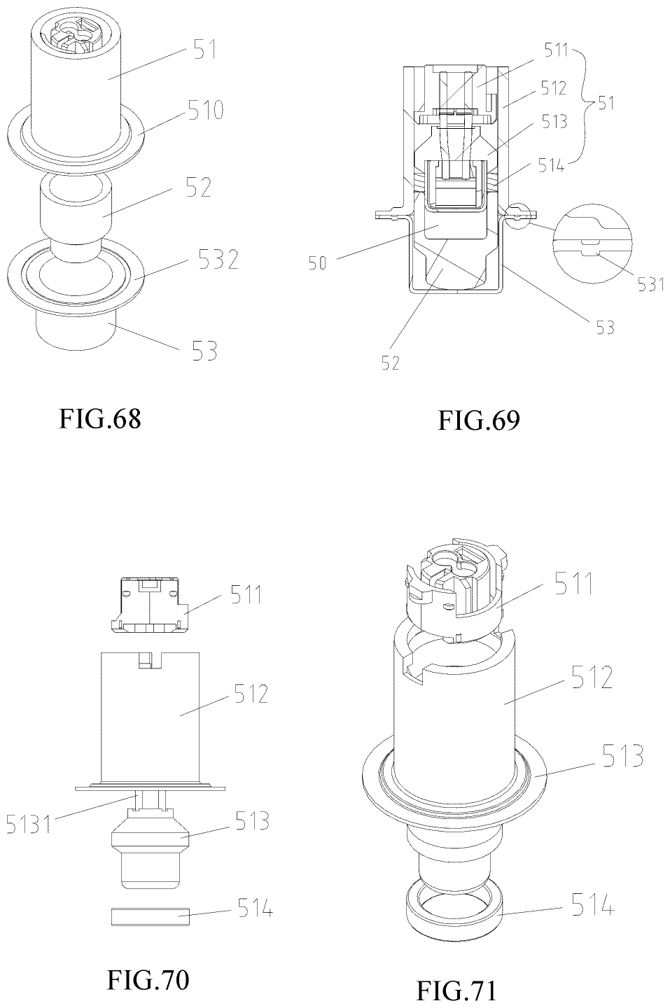

Referring to FIGS. 68-71, the pyrotechnic actuator 5 specifically includes an actuator 51, a piston 52 and a bottom shell 53. The actuator 51 and the bottom shell 53 are fixedly connected one above the other, and the piston 52 is accommodated between the actuator 51 and the bottom shell 53. The actuator 51 further includes a hollow actuator base 512, and a connector 511, an igniter 513 and a sealing ring 514 installed inside the actuator base 512. The actuator base 512 is a cylindrical structure, and a first flange 510 is provided at the lower end thereof. The bottom shell 53 is also a hollow cylindrical structure, and a second flange 532 is provided at the upper end of the bottom shell 53. The first flange 510 and the second flange 532 are connected and fixed (such as welding, riveting, or screwing) to achieve the connection and fixation of the actuator 51 and the bottom shell 53. The lower end of the bottom shell 53 extends into the contact chamber of the ceramic cover 6, and the second flange 532 is brazed and fixed on the ceramic cover 6 to achieve the fixed connection between the pyrotechnic actuator 5 and the ceramic cover 6. As shown in FIG. 69, an annular rib 531 is provided on the side of the second flange 532 facing the ceramic cover 6, and the annular rib 531 can further increase the stability of the brazing of the second flange 532 and the ceramic cover 6. In addition, the first flange 510 and the second flange 532 form an outwardly expanded diameter portion to further seal the mounting hole 61, the airtightness of the ceramic cover 6 can be ensured.

In this embodiment, the actuator base 512 and the bottom shell 53 are fixedly connected to form the outer housing of the pyrotechnic actuator 5. The connector 511, the igniter 513, the sealing ring 514 and the piston 52 are sequentially arranged inside the outer housing from top to bottom, and the connector 511 is connected to the lead 5131 of the igniter 513. The connector 511 is fixedly connected to the outer housing by clamping. The sealing ring 514 is pressed into the inner wall of the actuator base 512 by interference fit, and the actuator base 512 presses the igniter 513 upwards and fixes it. The upper and lower ends of the piston 52 are respectively pressed by the sealing ring 514 and the bottom shell 53. The sealing ring 514 can play roles of moisture-proof and air-tight. The micro-deformation of the sealing ring 514 under pressure can further press the igniter 513 above and the piston 52 below to prevent vibration loosening.

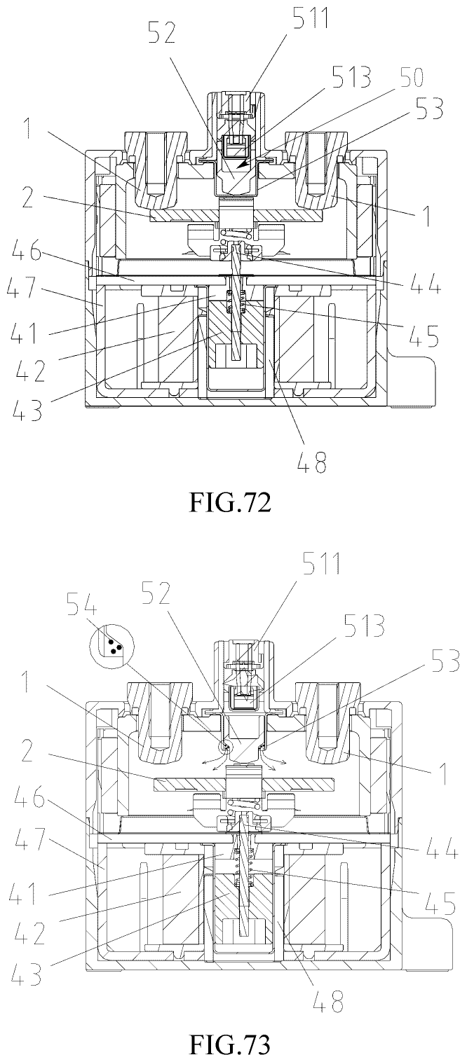

Referring to FIGS. 72-73, the connector 511 is used to fix the ignition lead of the monitoring excitation circuit to transmit the excitation electrical signal emitted by the monitoring excitation circuit to excite the igniter 513. The monitoring excitation circuit may emit an excitation electrical signal to be transmitted downward through the connector 511 after the monitoring current value (or current climbing rate) reaches a certain threshold value, and excite the igniter 513 to ignite. An air gap 50 is provided between the piston 52 and the igniter 513. After the igniter 513 ignites the gunpowder, high-pressure gas is generated in the air gap 50) (i.e., ignition is performed), pushing the piston 52 downward to break through the bottom shell 53, and then the piston 52 pushes the movable contact piece 2 downward to help the movable contact piece 2 disconnect with the contact with the static contact 1, so as to achieve the rapid disconnection of the relay.

The bottom shell 53 of the pyrotechnic actuator 5 is a hollow cylindrical structure, and the piston 52 is a rotating body structure arranged inside the bottom shell 53 through the shaft hole, so that the bottom shell 53 can guide the piston 52, and the piston 52 moves axially downward along the hollow cylindrical inner chamber of the bottom shell 53 after the igniter 513 is ignited.

In this embodiment, the pyrotechnic actuator 5 is a modular construction, which is independent from the relay body and can be produced separately and then fixedly installed on the relay. The production and transportation of the pyrotechnic actuator 5 are easy to control, the number of parts is small, and it is easy to assemble. The standardization of parts is also easier to achieve, so as to achieve the purpose of reducing weight, reducing costs and improving performance. In addition, the igniter 513 extends a lead 5131 to connect with the ignition lead of the monitoring excitation circuit through the connector 511, so that the gunpowder in the igniter 513 is far away from the lead-out end of the ignition lead, the temperature rise is low, and the temperature resistance requirement of the gunpowder is reduced.

As an example, in this embodiment, the pyrotechnic actuator 5 is applied to a ceramic sealed relay. Specifically, the pyrotechnic actuator 5 is welded to the ceramic cover 3. The welding has good tightness, the sealing and vibration resistance of the pyrotechnic actuator 5 are better, and the outer housing of the pyrotechnic actuator 5 is simpler to form, and the product height is lower. In other embodiments, the pyrotechnic actuator 5 can also be applied to the relay of other structures, as long as a mounting hole (such as the mounting hole 61 of this embodiment) is set on the relay body for the pyrotechnic actuator 5 to be inserted, and the pyrotechnic actuator 5 is attached to the relay by a fixed connection method. The pyrotechnic actuator 5 can also be fixed to the relay body by a detachable connection (such as a screw connection), so that the pyrotechnic actuator 5 can be quickly replaced according to input requirements.

As shown in FIG. 73, an arc-extinguishing medium 54 is also provided in the bottom shell 53. When the pyrotechnic actuator 5 is excited, the piston 52 is used to break through the bottom shell 53 downwards to release the arc-extinguishing medium 54 into the contact chamber of the ceramic cover 6, to extinguish the arc generated in the contact gap of the static contact 1 and the movable contact piece 2, which further accelerates the arc extinguishing ability when the contacts are disconnected and improves the short-circuit safety of the product. In this embodiment, the arc-extinguishing medium 54 is quartz sand. Since the gas at the lower end of the pyrotechnic actuator 5 expands rapidly after ignition and explosion, the arc-extinguishing medium 54 stored in the bottom shell 53 can be evenly spread in the contact chamber along with the explosion gas very quickly, and is not limited by the outer shape of the static contact 1 and the movable contact piece 2 and the inner contour of the contact chamber to the greatest extent, and can directly play the arc-extinguishing effect in a very short time. In this embodiment, the static contact 1 is arranged on two ends of the bridge-type movable contact piece, the pyrotechnic actuator 5 is disposed at one side of the middle section of the movable contact piece 2. After the pyrotechnic actuator 5 is ignited and exploded, the expansion gas will be blocked by the bridge-type movable contact piece, which makes the airflow go to two ends of the bridge-type movable contact piece, so that the arc-extinguishing medium 54 can reach the area between the static contact 1 and the movable contact piece 2 more directly.

In this embodiment, the arc-extinguishing medium 54 is stored in the bottom shell 53, which can effectively utilize the internal space of the pyrotechnic actuator 5 and is conducive to the miniaturization of the pyrotechnic actuator 5. Moreover, since the sealing ring 514 is provided in the actuator 51, the arc-extinguishing medium 54 can be protected from moisture. In addition, it is worth noting that in this embodiment, the lower end of the pyrotechnic actuator 5 extends into the inner part of the outer housing 3 to face the upper part of the movable contact piece 2, so that the piston 52 of this embodiment can be closer to the movable contact piece 2, the distance between the piston 52 and the movable contact piece 2 is shorter, and the stroke of the piston 52 is also shorter, so that the piston 52 can break the bottom shell 53 more quickly to release the arc-extinguishing medium 54, thereby achieving the effect of rapid arc extinguishing.

Referring to FIG. 72-73, the electromagnetic drive mechanism 4 is used to drive the movable contact piece 2 to move. The electromagnetic drive mechanism 4 specifically includes a static iron core 41, a coil 42, a movable iron core 43, a push rod assembly 44 and a reset spring 45, as well as a first yoke 46, a second yoke 47 and a magnetic cylinder 48 for transmitting magnetic lines of flux and improving the utilization rate of magnetic energy. The lower end of the push rod assembly 44 is fixedly connected to the movable iron core 43, and the upper end is linked to the movable contact piece 2. One end of the reset spring 45 acts on the static iron core 41, and the other end acts on the movable iron core 43. When the coil 42 is powered on, the static iron core 41 attracts the movable iron core 43 to move upward, so that the push rod 44 pushes the movable contact piece 2 upward; When the coil 42 is powered off, the electromagnetic drive mechanism 4 is reset under the elastic force of the reset spring 45. The electromagnetic drive mechanism 4 is a common direct-moving magnetic circuit structure, and its operating principle is not described in detail in this embodiment.

This embodiment uses a relay structure to illustrate the function and effect of the pyrotechnic actuator 5. In addition to the relay, the same structure can also be applied to other switch apparatuses, such as contactors.

### The Eighteenth Embodiment

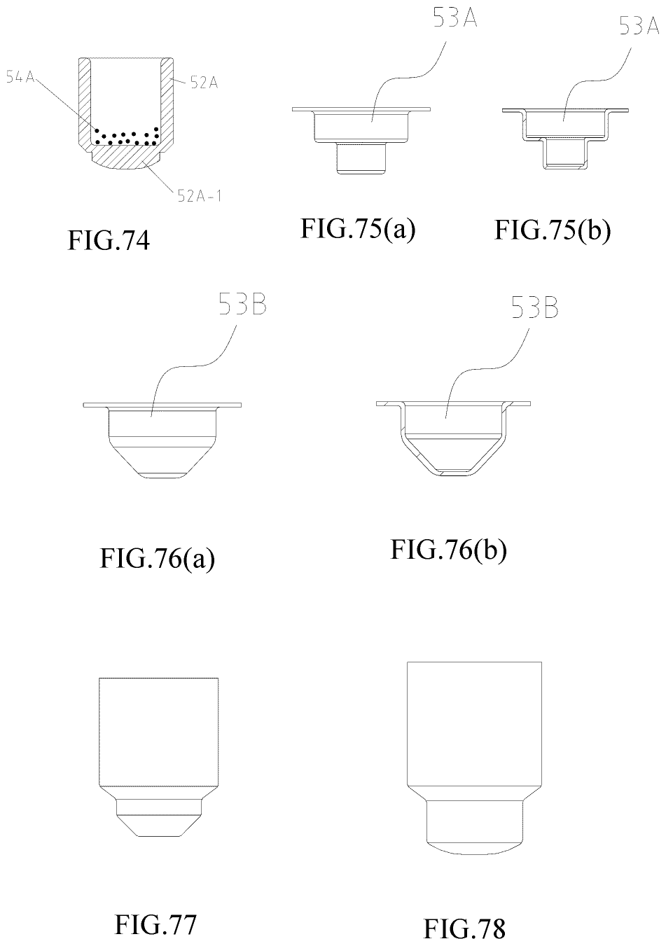

This embodiment proposes a relay, which has a structure similar to the relay of the seventeenth embodiment, the only difference is that in this embodiment, the arc-extinguishing medium is stored in the piston, as shown in FIG. 74, the piston 52A is provided with a groove with an opening facing upward, the arc-extinguishing medium 54A is stored in the groove of the piston 52A, and the lower end 52A-1 of the piston 52A (i.e., the impact part of the piston 52A) is a thin and fragile structure, when the piston 52A impacts downward, the lower end 52A-1 is broken due to the impact, and the crevice is generated, so that the arc-extinguishing medium 54a is released. Further, the lower end 52A-1 can be made of a fragile material such as BAKELITE®, PBT plastic, etc.

The piston structure with an upward opening in this embodiment and the seventeenth embodiment, in other embodiments, a central chamber of the piston can also be set as a sealed chamber, in which gaseous sulfur hexafluoride or liquid transformer oil and other arc-extinguishing medium can be sealed, that is, in addition to solid quartz sand, the arc-extinguishing medium of this embodiment can also be implemented by using other gaseous or liquid arc-extinguishing medium under the condition of ensuring sealing. The arc-extinguishing medium can be stored in the piston or in the bottom shell of the pyrotechnic actuator. Any solution that releases the arc-extinguishing medium by means of the explosive impact force generated by the pyrotechnic actuator is feasible, and the specific storage location of the arc-extinguishing medium can be determined according to actual needs and in combination with the properties of the arc-extinguishing medium.

### The Nineteenth Embodiment

This embodiment proposes a relay, whose structure is similar to the relay of the seventeenth embodiment, except that in this embodiment, an arc-extinguishing medium is provided in both the piston and the bottom shell. The arc-extinguishing medium of this embodiment is stored in both the piston and the bottom shell, which can increase the amount of the arc-extinguishing medium and improve the arc extinguishing ability.

### The Twentieth Embodiment

This embodiment proposes a relay, whose structure is similar to the relay of the seventeenth embodiment, and the only difference is that this embodiment adopts a different bottom shell structure of the pyrotechnic actuator. Referring to FIG. 75 (a) and FIG. 75 (b), in this embodiment, the bottom shell 53A is a multi-step structure with gradually shrinking radial dimensions from top to bottom. Since the lower end of the bottom shell 53A is in a shrinking shape, the impact force of the pyrotechnic actuator can be gathered on the small step at the lower end of the bottom shell 53A when it is ignited, thereby the local energy is increased, thus enhancing the ability of the piston to break the bottom shell 53A and accelerating the eruption of the arc-extinguishing medium.

As a variation of this embodiment. FIG. 76 (a) and FIG. 76 (b) show another feasible structure of the bottom shell 53B, where the bottom shell 53B is a conical structure whose radial dimension gradually shrinks from top to bottom (i.e., toward the movable contact piece). Similarly, since the lower end of the bottom shell 53B is in a contracted shape, the impact force of the pyrotechnic actuator when it is ignited can be gathered at the lower end of the bottom shell 53B, thereby achieving a local capacity increase, thereby enhancing the ability of the piston to break the bottom shell 53B and accelerating the eruption of the arc-extinguishing medium.

Regardless of whether it is “step-type contraction” or “cone-shaped contraction”, the structure of the bottom shell is set to gradually contract the radial dimension from top to bottom. In addition to the “step-type contraction” and “cone-shaped contraction” proposed in this embodiment, in other embodiments, the “step-type contraction” and “cone-shaped contraction” can be combined in multiple stages to achieve contraction, and the use of other regular or irregular shapes for radial contraction are all feasible solutions.

### The Twenty-First Embodiment

This embodiment proposes a relay, whose structure is similar to the relay of the seventeenth embodiment, and the only difference is that this embodiment adopts a different structure of the piston of the pyrotechnic actuator. In this embodiment, the piston is in a shape that contracts from top to bottom (i.e., toward the movable contact piece), and its force application area is reduced, and the force acting on the bottom shell and the movable contact piece is enhanced, so that the bottom shell can be broken faster, the movable contact piece can be quickly pushed to be disconnected from the static contact, and the eruption of the arc-extinguishing medium can be accelerated. The contraction shape of the lower end of the piston can be realized by using a conical contraction, a step contraction, or a contraction structure combining a conical and a step shape. The piston with a contracted lower end as shown in FIGS. 77 and 78 is feasible.

It should be understood that the application of the present disclosure is not limited to the detailed structure and arrangement of components provided in this specification. The present disclosure can have other embodiments, and can be implemented and carried out in various ways. The aforementioned variations and modifications fall within the scope of the present disclosure. It should be understood that the disclosure disclosed and described in this specification may extend to all alternative combinations of two or more individual features that are apparent or mentioned in the text and/or drawings. All of the different combinations form various alternative aspects of the present disclosure. Embodiments described in this specification illustrate the best modes known for carrying out the present disclosure, and will allow those skilled in the art to utilize the present disclosure.

1. A switch apparatus having a pyrotechnic actuator, comprising:
a switch body; comprising a static contact part fixedly disposed and a movable contact part movably disposed; to perform a switch function; and
a pyrotechnic actuator; being an independent modular construction, fixedly installed on the switch body from an outside of the switch body, wherein the pyrotechnic actuator is adapted to ignite gunpowder according to a load condition of the switch body to generate an explosive impact force that pushes the movable contact part away from the static contact part, so as to assist the switch apparatus to disconnect quickly.

2. The switch apparatus according to claim 1, wherein the switch body comprises an outer housing, the movable contact part is provided inside the outer housing, and the pyrotechnic actuator extends into the outer housing and faces one side of the movable contact part.

3. The switch apparatus according to claim 2, wherein the pyrotechnic actuator comprises:
an actuator;
a bottom shell, being a hollow structure, the actuator and the bottom shell are joined and fixed together, the bottom shell extends into the outer housing and faces the movable contact part; and
a piston; being cooperatively installed in the bottom shell;
wherein when the pyrotechnic actuator is excited, the actuator ignites gunpowder to generate gas, and the gas pushes the piston to break through the bottom shell, the piston moves toward the movable contact part under the guidance of the bottom shell, thereby pushing the movable contact part to be away from the static contact part.

4. The switch apparatus according to claim 3, wherein the bottom shell is a structure that gradually contracts in a direction toward the movable contact part.

5. The switch apparatus according to claim 3, wherein the piston is a structure that gradually contracts in a direction toward the movable contact part.

6. The switch apparatus according to claim 3, wherein an arc-extinguishing medium is further stored in the piston or the bottom shell, and, after the piston breaks through the bottom shell, the arc-extinguishing medium is released to extinguish an arc between the static contact part and the movable contact part.

7. The switch apparatus according to claim 3, wherein the actuator comprises a hollow actuator base, a first flange is provided at one end of the actuator base, a second flange is provided at one end of the bottom shell, and the first flange and the second flange are connected and fixed to each other so that the actuator and the bottom shell are connected and fixed together.

8. The switch apparatus according to claim 7, wherein the second flange is fixed to the outer housing by welding, and the second flange is provided with an annular rib for improving the stability of welding.

9. The switch apparatus according to claim 7, wherein the actuator further comprises:
a connector, fixedly installed inside the actuator base, the connector is fixed on an inner wall of the actuator base by clamping,
an igniter, fixedly installed inside the actuator base; and
a sealing ring, fixedly installed inside the actuator base, and the sealing ring is pressed into the actuator base by interference fit, one end of the sealing ring presses the igniter toward the connector, and the other end of the sealing ring presses the piston toward the bottom shell.

10. The switch apparatus according to claim 2, wherein the switch body further comprises:
a ceramic cover, arranged inside the outer housing and covers the static contact part, the movable contact part, and the contact parts of the static contact part and the movable contact part,
wherein the ceramic cover is provided with a mounting hole, one end of the pyrotechnic actuator passes through the mounting hole and is welded and fixed to the ceramic cover, and the mounting hole is sealed.

11. The switch apparatus according to claim 1, wherein the pyrotechnic actuator is connected to the switch body in a detachable manner.

12. The switch apparatus according to claim 1, wherein the switch apparatus is a direct current high voltage relay.

13. A system, comprising:
a switch apparatus having a pyrotechnic actuator, comprising:
a switch body comprising a static contact part fixedly disposed and a movable contact part movably disposed to perform a switch function; and
a pyrotechnic actuator having an independent modular construction, the pyrotechnic actuator being fixedly installed on the switch body from an outside of the switch body,
wherein the pyrotechnic actuator is configured to ignite gunpowder according to a load condition of the switch body to perform a disconnection by generating an explosive impact force that pushes the movable contact part away from the static contact part.
